(19) United States
(12) Patent Application Publication
(10) Pub. No.: US 2009/0210748 A1
(43) Pub. Date: Aug. 20, 2009

(54) METHODS AND SYSTEMS TO TEST AIRLINE INFORMATION SYSTEMS

(75) Inventors: Andreas Hohmann, Watertown, MA (US); James Carter, Boston, MA (US)

Correspondence Address: GARRETT IP, LLC;C/O CPA Global, P.O. BOX 52050, MINNEAPOLIS, MN, 52050, US

(73) Assignee: ITA Software, Inc., Cambridge, MA (US)

(21) Appl. No.: 12/388,225

(22) Filed: Feb. 18, 2009

Related U.S. Application Data
(60) Provisional application No. 61/029,548, filed on Feb. 18, 2008.
(60) Provisional application No. 61/045,613, filed on Apr. 17, 2008.
(60) Provisional application No. 61/114,368, filed on Nov. 13, 2008.

(51) Int. Cl. G06F 11/28; G06F 9/455

(52) U.S. Cl. 714/32; 703/21; 714/E11.178

(57) ABSTRACT

Methods and systems to simulated a plurality of airline information systems (AISs) to test an AIS under test (AISUT), including to send and receive messages between the simulated AISs, and to send messages to and receive messages from the AISUT, in accordance with communication parameters associated with the corresponding AISs and AISUT. The AISUT and/or the simulated AISs may be stimulated to cause interaction with the AISUT, and resultant messages and information may be recorded. Stimulation may include controlling a web browser to interact with a web application of the AISUT. AISs may be represented as travel system objects, which may be associated with corresponding AIS-specific message handling and reporting parameters. Message processing logic may be configured to process messages, such as booking request messages, directed to a plurality of the simulated AISs, and the travel systems and the message processing logic may be modifiable independent of one another.

### CROSS REFERENCE TO RELATED APPLICATIONS

This patent application claims the benefit of U.S. Provisional Application Ser. No. 61/029,548, titled, “JAVA TEST BED” filed Feb. 18, 2008, U.S. Provisional Application Ser. No. 61/045,613, titled, “JAVA-BASED TEST BED FOR AN AIRLINE RESERVATION SYSTEM” filed Apr. 17, 2008, and U.S. Provisional Application Ser. No. 61/114,368, titled, “METHODS AND SYSTEMS TO TEST AIRLINE RESERVATION SYSTEMS” filed Jan. 13, 2009, which are incorporated herein by reference in their entireties.

### TECHNICAL FIELD

Methods and systems to test airline information systems, including to simulate operations of one or more other airline information systems.

### BACKGROUND

Airline information systems, such as airline reservation systems, are characterized by complex interactions between many systems, such as other airlines, global distributions systems, clearing houses, partner companies, and payment systems, using a variety of protocols.

Testing an airline information system is inherently difficult because of the relatively large number of potential scenarios to be tested, which may involve external systems. Testing in a realistic context may not be possible due to insufficient access to the external systems.

Testing of an airline information system is also difficult during initial development due to periodic design changes. A relatively large set of tests may need to be executed many times to ensure that changes to the reservation system do not lead to regression.

### SUMMARY

Methods and systems are disclosed herein to simulate a plurality of airline information systems (AISs) and to test an AIS under test (AISUT), including to send and receive messages between the simulated AISs, and to send messages to and receive messages from the AISUT, in accordance with communication parameters associated with the corresponding AISs and AISUT.

The AISUT and/or the simulated AISs may be stimulated to cause interaction with the AISUT, and resultant messages and information may be recorded. Stimulation may include controlling a web browser to interact with a web application of the AISUT.

AISs may be represented as travel system object, which may be associated with corresponding AIS-specific message handling and reporting parameters. Message processing logic may be configured to process messages, such as booking request messages, directed to a plurality of the simulated AISs, and the travel systems and the message processing logic may be modifiable independent of one another.

One or more features disclosed herein, and combinations thereof, may be implemented with object-oriented computer programming, including, without limitation, JAVA-based computer programming.

### BRIEF DESCRIPTION OF THE DRAWINGS/FIGURES

FIG. 1 is a block diagram of an exemplary airline information system (AIS) test environment, including a test system to test an airline information system under test (AISUT).

FIG. 2 is a block diagram of another exemplary AIS test environment, including the test system coupled to exemplary components of an AISUT.

FIG. 3 is a block diagram of another exemplary AIS test environment, wherein the test system includes a test driver and a simulator.

FIG. 4 is a graphical illustration of another exemplary AIS test environment, including the AISUT, the test driver, and the simulator.

FIG. 5 is a graphical illustration of another exemplary AIS test environment, wherein the test driver is configured to interface with the AISUT through an airline call center agent terminal and a user computer.

FIG. 6 is a process flowchart of an exemplary method of testing an airline information system.

FIG. 7 is a process flowchart of another exemplary method of testing an airline information system.

FIG. 8 is a graphical illustration of another exemplary AIS test environment.

FIG. 9 is a graphical illustration of an exemplary class test model.

FIG. 10 is a graphical illustration of an exemplary test listener model.

FIG. 11 is a graphical illustration of an exemplary class test case model.

FIG. 12 is an exemplary graphical user interface, including information related to a test execution.

FIG. 13 illustrates exemplary interfaces for input and output of EDIFACT messages.

FIG. 14 illustrates exemplary EDIFACT schema classes.

FIG. 15 is a graphic illustration of a class EDIFACT-node.

FIG. 16 illustrates exemplary classes involved in reading and writing fixed length records.

FIG. 17 illustrates exemplary class teletype interfaces.

FIG. 18 illustrates an exemplary class teletype-message.

FIG. 19 is a graphic illustration of an exemplary class AIRIMP ssr-streamer.

FIG. 20 illustrates an exemplary page model design.

FIG. 21 is a class model diagram of an exemplary reservation class model.

FIG. 22 is a class model diagram of an exemplary SpecialService class model.

FIG. 23A is a graphic illustration of an exemplary meal service process.

FIG. 23B is a class model diagram of an exemplary medical service class model.

FIG. 24 is a model diagram of an exemplary HTTP request handler model.

FIG. 25 is a graphical illustration of an exemplary HTTP request handler model.

FIG. 26 is a graphic illustration of exemplary request handlers.

FIG. 27 is a graphic illustration of teletype request handler model.

FIG. 28 is a graphic illustration of an EDIFACT request handler function.

FIG. 29 is a graphic illustration of an exemplary XmlRequestHandler.

FIG. 30 is a graphic illustration of a travel system environment, including a TravelSystem.

FIG. 31 is a graphic illustration of another travel system environment.

FIG. 32 is a graphic illustration of a booking session environment.

FIG. 33 is a graphic illustration of an exemplary booking and reservation session environment.

FIG. 34 is a graphic illustration of an ARIMP reservation message environment.

FIG. 35 is a graphic illustration of a default booking and reservation session environment.

FIG. 36 is a graphic illustration of an exemplary reservation session environment.

FIG. 37 is a graphic illustration of an exemplary reservation events environment.

FIG. 38 is a graphic illustration of a reservation history event environment.

FIG. 39 is a graphic illustration of a reservation rules environment.

FIG. 40 is a graphic illustration of a reservation channel environment.

FIG. 41 is a graphic illustration of an exemplary reservation channel configuration environment.

FIG. 42 is a graphic illustration of an exemplary rule-based reservation listener environment.

FIG. 43 is a block diagram of an exemplary computer system.

FIG. 44 is an exemplary block diagram of simulator logic.

FIG. 45 is an exemplary block diagram of message handler logic.

FIG. 46 is a block diagram of an exemplary travel system environment.

In the drawings, the leftmost digit(s) of a reference number identifies the drawing in which the reference number first appears.

### DETAILED DESCRIPTION

Disclosed herein are methods and systems to test airline information systems, and to simulate operations of one or more other airline information systems.

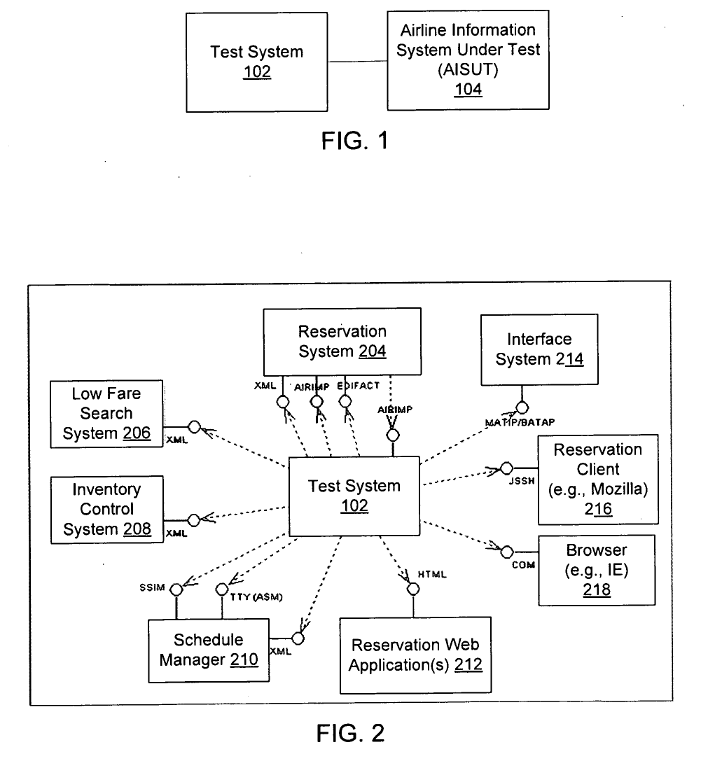

FIG. 1 is a block diagram of an exemplary airline information system (AIS) test environment 100, including a test system 102 to test an airline information system under test (AISUT) 104. AISUT 104 may be configured to perform operations with respect to one or more of airline reservation booking, inventory control and availability, including seating availability, airline routing, low-fare searching, airline scheduling, customer information, and customer rewards. AISUT 104 may be configured to interface with one or more other computer systems to permit users, travel agents, and/or airline employees to buy, sell, and manage products and services.

FIG. 2 is a block diagram of another exemplary AIS test environment 200, including test system 102 coupled to exemplary components of an AISUT, such as AISUT 104. An AISUT may include one or more of a reservation system 204, a low fare search system 206, an inventory control system 208, a schedule manager system 210, one or more web applications 212, and an airline information systems interface system 214.

AISUT 104 may include one or more client or user interfaces, illustrated here as browser-based interfaces 216, which may include an Internet Explorer browser-based interface available from Microsoft Corporation, and client interfaces 218, which may include a Firefox browser-based interface available from Mozilla organization, which may be configured as a travel agent terminal. AISUT 104 may include an airline availability system.

Test system 102 may be configured to communicate with AISUT 104 and/or components thereof, over one or more protocol interfaces, which may include HTTP or airline transport protocols such as BATAP or HTH over MATIP.

The term BATAP is used herein to refer to Type B Application to Application protocol. Protocol to Secure the Type B traffic. It was specified by SITA and published by IATA.

The term MATIP is used herein to refer to Mapping of Airline traffic over Internet protocol. A standard defined in RFC2351 for airline messaging traffic.

Test system 102 may be configured to communicate with AISUT 104 and/or components thereof, with messages having one or more content types, including, without limitation, XML, EDIFACT, and Teletype (e.g., AIRIMP). FIG. 2 includes exemplary message content types between test system 102 and components of AISUT 104. Test system 102 may be configured to communicate directly with AISUT 104 and/or components thereof.

Components of AISUT 104 may communicate and interact with one another and with other AISs.

Test system 102 may include a test driver to stimulate one or more components and combinations of components of AISUT 104 and to record information resulting therefrom, such as information generated and/or stored by one or more components, messages passed between components, and screen shots from browser-based interfaces.

Test system 102 may include a simulator to simulate one or more airline information systems, and a test driver to stimulate one or more components and combinations of components of AISUT 104 and/or the simulator.

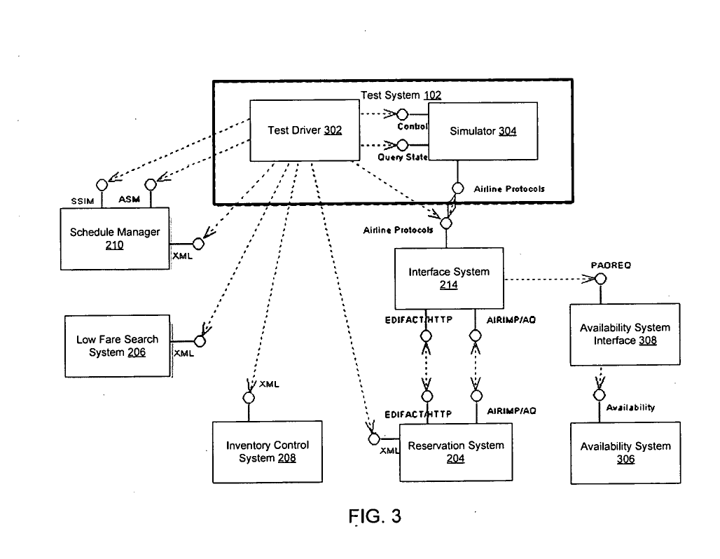

FIG. 3 is a block diagram of another exemplary AIS test environment 300, wherein test system 102 includes a test driver 302 and a simulator 304. In the example of FIG. 3, AISUT components include an availability system 306 and an availability system interface 308.

In the example of FIG. 3, test driver 302 is configurable to stimulate one or more AISUT components 204, 206, 208, 210, and 214, and simulator 304, over one or more transport protocol interfaces.

Referring back to FIG. 3, test driver 302 may be configured to control simulator 304 and to query state before and after execution of tests. Test driver 302 may be configured to indirectly stimulate AISUT 104 (FIG. 1), such as by sending requests to simulator 304 to cause simulator 304 to send messages to AISUT 104. For example, test driver 302 may be configured to send a booking request to a simulated GDS AIS 406, to cause the simulated GDS AIS 406 to send a sequence of EDIFACT messages to AISUT 104. Test driver 302 may be configured to stimulate AISUT through one or more browser interfaces, and may be configured to control one or more browser processes. For example, and without limitation, test driver 302 may be configured to start, stop, and/or ping a browser, such as to determine whether the browser is operational.

Simulator 304 may be configured to model one or more AISs 108, or portions thereof, to simulate processing of reservations, tickets, special services, schedules, and/or inventory, in response to messages, and to generate corresponding response messages.

Messages may include reservation booking requests to create and/or modify reservation information.

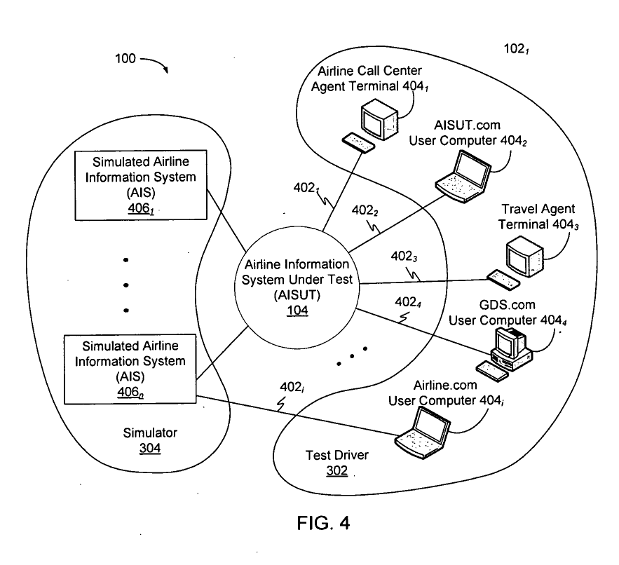

FIG. 4 is a graphical illustration of another exemplary AIS test environment 400, including AISUT 104, test driver 302, and simulator 304.

Simulator 304 may include logic to simulate a plurality of AISs 406, through 406ₙ. Simulated AISs 406₁ through 406ₙ may represent, for example and without limitation, one or more of an AIS that is operated and/or maintained by and/or on behalf of a corresponding airline company, a global distribution system (GDS), a clearing house, a partner company, and a payment system.

Test driver 302 may include logic to generate outputs 402₁ through 402ᵢ, to stimulate one or more of AISUT 104 and simulated AISs 406. Outputs 402₁ through 402ᵢ may correspond to one or more user devices 404₁ through 404ᵢ, with which AISUT 104 and/or AISs 406 are configured to interface.

Test driver 302 may include logic to record data changes and/or interactions in response to outputs 402₁ through 402ᵢ.

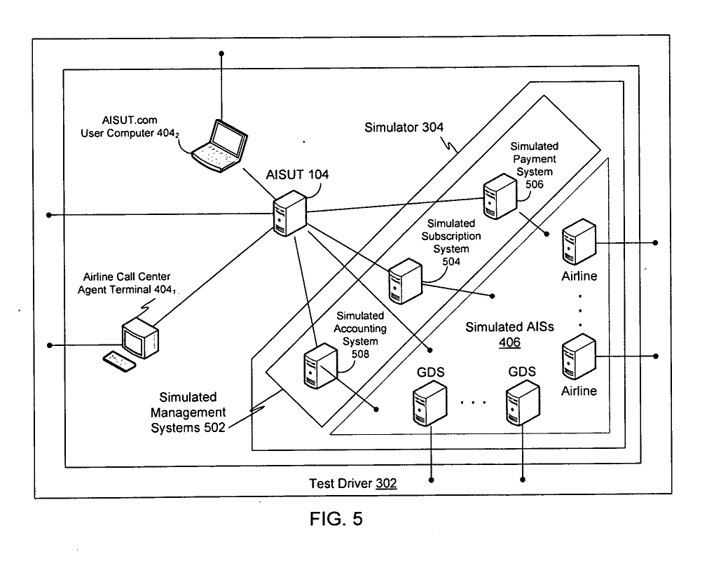

FIG. 5 is a graphical illustration of another exemplary AIS test environment 500, wherein test driver 302 is configured to interface with AISUT 104 through airline call center agent terminal 404₁ and user computer 404₂. Test driver 302 is further configured to interface with simulator 304, including to interface with one or more simulated AISs 406 and one or more simulated management systems 502. Simulated management systems 502 may include one or more of a simulated subscription system 504, a simulated payment system 506, and a simulated accounting system 508.

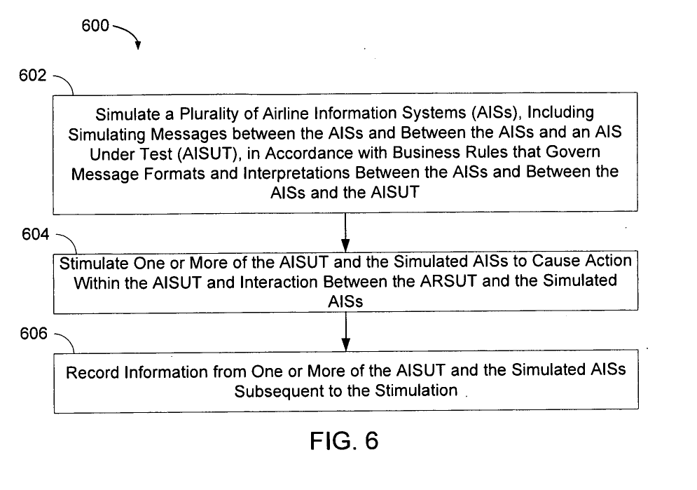

FIG. 6 is a process flowchart of an exemplary method 600 of testing an airline information system, such as AISUT 104.

At 602, a plurality of AISs is simulated. The simulating may include simulating messages between the AISUT and one or more of the AISs, and may include simulating messages between the AISs. The simulating may include generating and receiving messages, with respect to the simulated AISs, in accordance with business rules that govern message formats and interpretations between the AISs and the AISUT.

At 604, one or more of the AISUT and one or more simulated AISs are stimulated to cause action within the AISUT and interaction between the AISUT and one or more of the simulated AISs.

At 606, information is recorded from one or more of the AISUT and the simulated AISs subsequent to the stimulation.

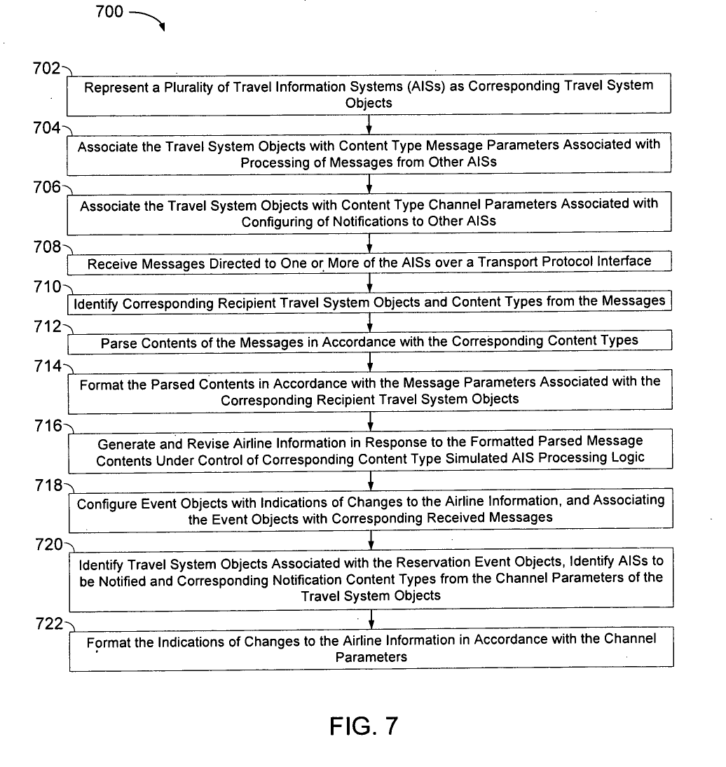

FIG. 7 is a process flowchart of an exemplary method 700 of testing an airline information system.

At 702, AISs are represented as corresponding travel system objects in a computer system.

At 704, the travel system objects are associated with message parameters to assist in processing of messages received from other AISs, which may include one or more of the AISUT and one or more simulated AISs. The message parameters may include message parameters associated with one or more message content types, which may include one or more of XML messages, EDIFACT messages, and teletype messages.

At 706, the travel system objects are associated with channel parameters to assist in preparing messages to other AISs, which may include one or more of the AISUT and one or more simulated AISs. The channel parameters may include channel parameters associated with one content type messages, which may include one or more of XML messages, EDIFACT messages, and teletype messages.

At 708, messages directed to one or more of the simulated AISs or recipient AISs are received. The messages, or a portion thereof, may be received over one or more protocol interfaces, which may include HTTP and/or one or more airline transport protocols, such as BATAP and HTH over MATIP.

Configuration of travel system objects as described herein, and handling of messages as described herein, may permit simulator 304 to process messages with logic that is generic to, or can be applied to message requests associated with a plurality of travel systems or simulated AISs 406. This may permit changes to travel systems and additions of new travel systems, substantially without affecting the message processing logic. Similarly, this may permit changes to the processing logic substantially without affecting the travel systems.

At 710, travel system objects corresponding to the recipient AISs, or recipient travel system objects, and corresponding message content types, are identified from the received messages. The travel system objects and message content types may be identified under control of a transport protocol message handler corresponding to the transport protocol interface.

At 712, contents of the received messages are parsed in accordance with the corresponding message content types. The messages may be parsed under control of corresponding message content type handlers. The message handlers may be identified and/or invoked in response to the transport protocol message handler.

At 714, the parsed message contents are formatted in accordance with the corresponding content types. The formatting may be performed in accordance with message parameters associated with the corresponding travel system objects, described above with respect to 704.

At 716, the formatted message contents are processed. The processing may include generating and/or revising airline booking records in response to instructions contained within booking request messages. The processing may be performed in accordance with, or under control of corresponding content type booking logic configured to process corresponding content type messages.

At 718, event objects may be configured with indications of changes resulting from the processing of messages at 716, and may be associated with corresponding received messages. Where the messages include booking requests, corresponding reservation event objects may be configured with indications of corresponding changes to airline booking records.

At 720, travel system objects corresponding to the received messages, and associated channel parameters are identified. The channel parameters are used to identify one or more AISs to be notified of the changes associated with the event objects, associated message content types, and AIS-specific formatting parameters.

At 722, notifications corresponding to the event objects are generated in accordance with the channel parameters.

Referring back to FIG. 3, test driver 302 may include one or more test cases configured to stimulate, or initiate one or more messages. Various parallel requests and corresponding responses may occur between AISUT 104 and one or more simulated AISs 406. A test case may be configured to stimulate AISUT 104 and/or one or more simulated AISs 406, through one or more corresponding interfaces, and to check corresponding response messages, including messages received and sent by simulator 304, and other state changes.

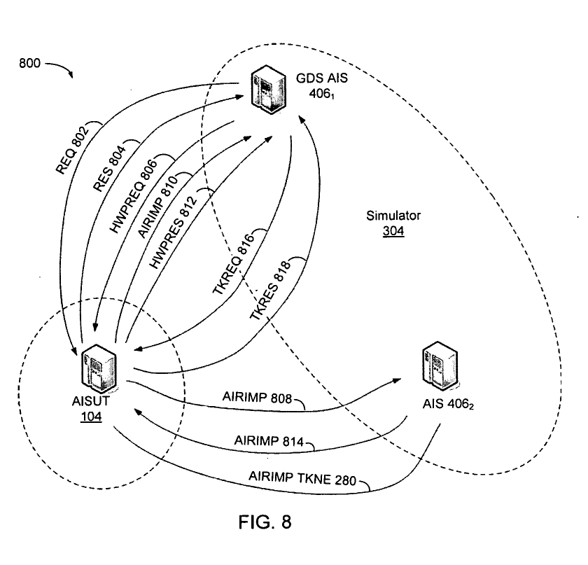

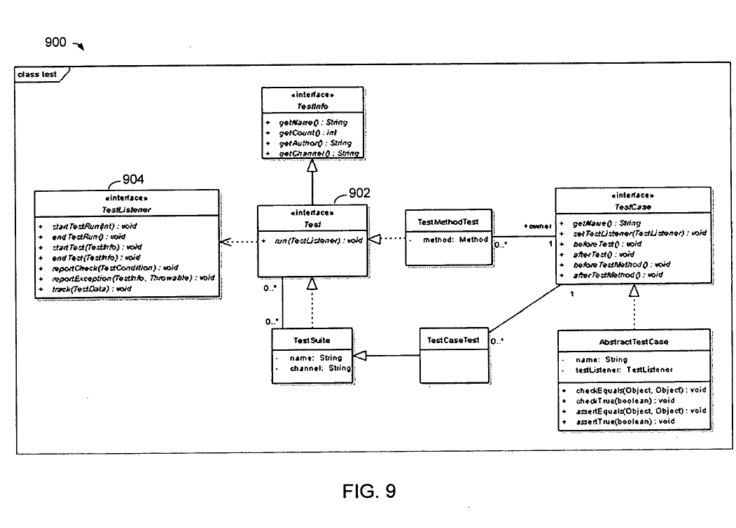

FIG. 8 is a graphical illustration of another exemplary AIS test environment 800, including AISUT 104 and simulator 304. In the example of FIG. 8, simulator 304 includes a simulated GDS AIS 406₁ and a simulated AIS 406₂, which may represent a partner airline associated with AISUT 104.

In the example of FIG. 8, simulated GDS AIS 406₁ is controlled to send a reservation request 802 to AISUT 104. In response, AISUT 104 sends an acknowledgement or response RES message 804, which is received by simulated GDS AIS 406₁. Simulated GDS AIS 406₁ subsequently sends a HWPREQ message 806 to AISUT 104. In response, AISUT 104 may send an ARIMP message 808a to a corresponding partner airline, which may be received by simulated AIS 406₂. AISUT 104 may also send an ARIMP message 810, and a HWPRES message 212, which may be received by simulated GDS AIS 406₂.

In response to AIRIMP message 806, simulated AIS 406₂ may send an ARIMP message 814 to AISUT 104. The AIRIMP message 814 may include a booking request.

Simulated GDS AIS 406₁ may send a TKTREQ message 816 to AISUT 104 to initiate ticketing.

AISUT 104 may send a TKTRES message 818, which may be received by simulated GDS AIS 406₁.

Simulated AIS 406₂ may send an AIRIMP TKNE message 820 to AISUT 104.

Referring back to FIG. 1, test system 102 may be implemented with object-oriented programming, such as JAVA, using a JAVA-based framework to create and automatically run tests. Such object-oriented programming may be configured to encapsulate or associate attributes of airline travel information systems, communication channels, and messages in and/or with corresponding objects. The objects may include generic classes for attributes that are generic throughout an environment, and may include specialized classes or parameterized classes for attributes, behaviors, and/or strategies that are not generic throughout the environment. For example, and without limitation, specialized classes or parameterized classes may be configured to handle aspects of communication channels, such as point-to-point communication channels and/or corresponding messages, to simulate the communication channels and/or messages using protocols that are native to a corresponding system and/or in accordance with business rules that govern message formats and interpretations between systems.

A JAVA-based framework may enable relatively efficient writing, running, analyzing, and maintaining of tests, allowing testers to focus functionality rather than adapting tests to software changes, manually capturing and interpreting test results, and searching through disparate log files.

Test system 102 may be configured to interface with one or more components of AISUT 104 using protocols that are native to the corresponding components. The protocols may include proprietary XML protocols, conventional airline protocols, such as EDIFACT and teletype (TTY), transport protocols, such as HTTP, MATIP, BATAP, and HTH, and user interfaces, such a Mozilla Firefox and Microsoft Internet Explorer.

Test system 102 may be configured to store reference data related to one or more of airlines, airports, and cities in one or more databases. The data may be initialized by importing files into the database. Tests running on test system 102 may be configured to load reference data from the one or more databases when the tests are run and/or when simulator 304 is invoked.

Test system 102 may be configured with respect to an integrated development environment (IDE) in which to develop and run tests or test cases. Information gathered during test case execution may be linked to corresponding test case definitions. Test results may be collected and tracked over time.

Test system 102 may be configured to permit test development at relatively higher-level abstraction layers, which may permit test developers to create test cases without extensive knowledge of underlying protocols. Higher-level abstraction layers may also reduce impacts of application changes, such as protocol changes, on existing test cases.

Test system 102 may be configured to substantially decouple test case definitions from application details.

Test system 102 may be configured to utilize static typing, wherein messages are implemented with or as objects. This may result in corresponding test code containing relatively little or no string processing. Message objects may also reduce configuration efforts, as needed changes may be identified by a compiler. Message objects may also minimize learning time and programming time, as test developers may examine message objects using an integrated development environment (IDE) content assist.

Test system 102 may be configured with JAVA based programming for one or more of a framework and test definitions, which may permit a relatively high degree of complexity of test cases.

Test system 102 may be configured with options to factor out commonalities between test cases, such as inheritance, builders, factories, and templates.

Test system 102 may be configured with respect to an extensible development environment, such as in a form of an Eclipse integrated development environment (IDE), which may provide re-factoring and debugging support, which may reduce or minimize maintenance costs.

Test system 102 may be configured with libraries for XML, using JAXB, database access using Hibernate, and web front ends using Grails, for interfaces and reporting.

Test system 102 may be configured to include an extensible build environment, using Maven and Hudson, including integration with Eclipse.

Test system 102 may be configured to use a JAVA open source stack, such as the Spring framework to combine and configure test components such as interfaces to tested systems.

Test system 102 may be configured to exercise or run a test within one or more process, and/or within one or more virtual machines. For example, test system 102 may be configured to exercise or run a test within a single process or virtual machine, and to process all or substantially all requests and response messages within the test.

Exemplary functions and features of test system 102 are disclosed below in terms of a test framework, user interface (UI) test support, messages and protocols, and support and libraries. Test system 102 is not, however, limited to the examples below.

A test framework may include a JAVA based framework to write functional tests, and may be similar to JUnit, version 3.

The test framework may be configured with one or more of Eclipse and Maven plug-ins, such as to execute test cases within a development environment and/or in a batch-mode. Test results may be stored in a database and then analyzed with a web application.

Test system 102 may include a user-interface (UI) test support to facilitate UI tests. Each page of a UI may be represented by a page-builder class that provides access to elements on the page as JAVA properties, which may shield the UI test definitions from the layout and markup of the pages. Test system 102 may include page builders for all or page or a portion thereof. To test web applications directly, such as for load testing, test system 102 may be configured to integrate with Grinder, available at http://grinder.sourceforge.net/.

For messages and protocols, test system 102 may be configured to support one or more of XML, EDIFACT, and Teletype messages as well as fixed-length records.

JAVA classes representing messages may be generated from schema definitions, including for example, and without limitation, classes for PADIS, IATCI, APIS, SSIM, and XML (via JAXB) interfaces for various component of AISUT 104 and/or simulated AISs 406. Test system 102 may be configured to interface with AISUT 104 over one or more transport protocol interfaces, which may include one or more of a HTTP interface, a MATIP over BATAP interface, and a HTH interface. Transformation and builder classes may be utilized to permit tests to be written for multiple interfaces.

Support libraries may be configured to fill gaps left by standard JAVA libraries, such as for date and time classes, including system-compliant time zones, and a key-based logging application programming interface (API).

Exemplary functions and features of a test framework are described below.

FIG. 9 is a graphical illustration of an exemplary class test model 900, including exemplary interfaces and classes of a test framework. Model 900 can be viewed as a variation of a JUnit model with a focus on detailed tracking of test executions. In the example of FIG. 9, model 900 includes a Test interface 902 and a TestListener interface 904. Test interface 902 may be implemented, directly or indirectly, by a test application. TestListener interface 904 may permit a test to talk to the testing environment while the test is running.

Checks performed during test execution may be reported to a test listener independent of the test outcome. A check may include one or more of a “plain” check and an assertion. If a “plain” check fails, test execution may continue. If an assertion fails, the test may be interrupted.

A check may be modeled as a sub-class of an abstract test condition class. Sub-classes may implement the evaluate method that checks the condition.

Application-specific conditions may be introduced by defining new test condition sub-classes.

A test may pass arbitrary binary data in form of an object to a test listener. This may be used to track messages and screen shots.

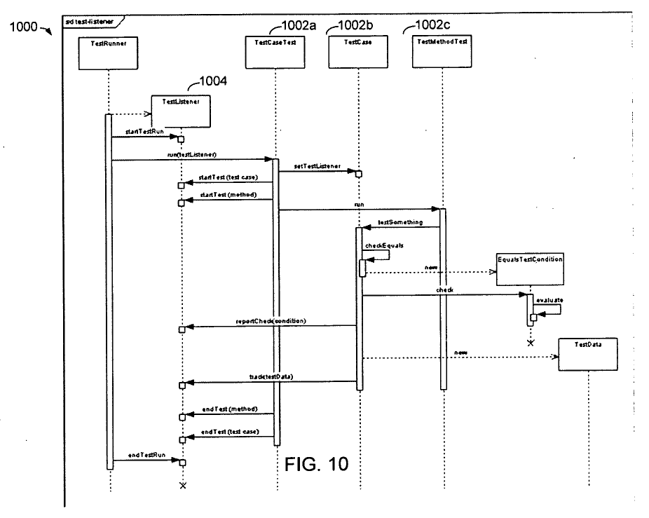

One or more tests may not implement the test interface directly, but instead may extend an application-specific sub-class that implements a test interface. FIG. 10 is a graphical illustration of an exemplary test listener model 1000, to illustrate exemplary interactions between TestCases 1010 and a TestListener 1004.

Test system 102 may be configured to run a test from Eclipse or Maven, and the test may be executed in a sandbox to accommodate different classpaths utilized by a hosting application (e.g., Eclipse or Maven) and the test itself, and to avoid a test crashing the environment in which it is running when a test is being worked on. Where the execution environment may not be able to pass a test listener object directly to the test, a communication channel that works across the classpath and even JVM boundaries (in the case of Eclipse), may be generated. Alternatively, or additionally, a command line application may be utilized for batch test execution.

Test system 102 may be configured to store results of a test execution in a database. The results may be linked to test cases, test scripts, and environments.

A test script may define the instruction of one or more test cases. Test cases may be structured to contain input data that is used when running the test. A test execution may capture the information regarding execution of a test case. Information collected during and/or following a test execution may include results, conditions, and data, such as messages and screenshots, and exceptions.

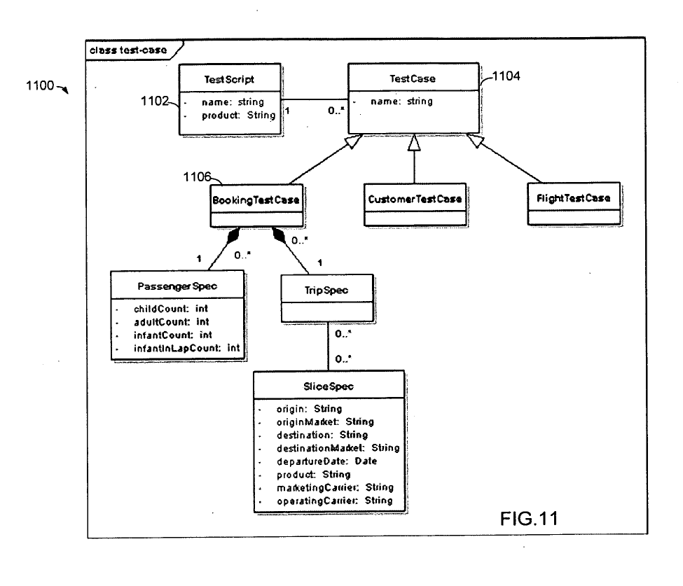

FIG. 11 is a graphical illustration of an exemplary class test case model 1100. A test script 1102 may include variables for input data that have to be defined for each test case 1104 that uses the test script. Input data for different test scripts may be modeled as sub-classes of a test case. A booking test case 1106, for example, may provides input data for test case 1104 following a booking test script (search, select, provide passenger information, provide payment information).

A web application of test system 102 may be configured to provide access to test data and test results, such as to permit browsing through prior test runs, to view information related to individual test cases, and to enter meta-data for test cases and test scripts. The web application may be generated using a Grails framework, including Groovy application code, GSP pages, Spring configuration and Hibernate for persistence.

Exemplary functions and features of test cases and test executing are now described.

Test system 102 may include one or more plug-in modules. For example, and without limitation, an Eclipse plug-in, or variation thereof, may be utilized during development of a test. A Maven plug-in, or variation thereof, may be used to run a suite or batch of tests in a serial fashion, followed by persisting the results in a database.

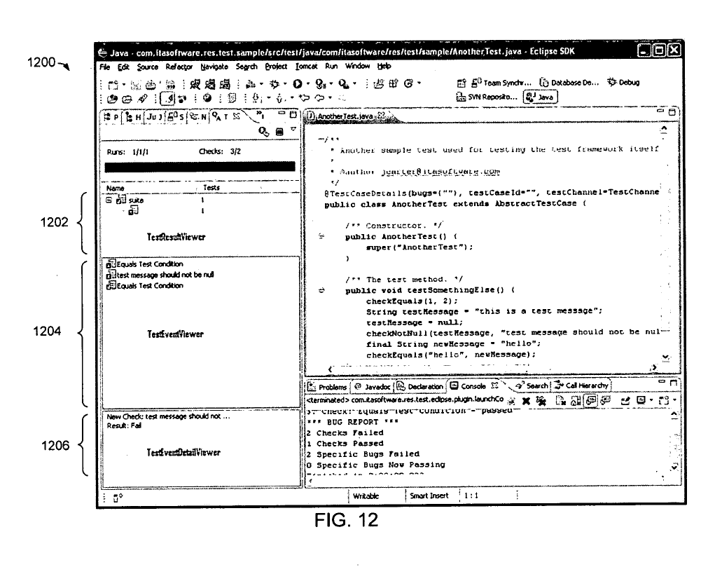

FIG. 12 is an exemplary graphical user interface (GUI) 1200, including information related to a test execution. When a test is selected in a top portion 1202 of GUI 1200, corresponding test events may be displayed in a middle portion 1204. When a test event is selected in middle portion 1204, corresponding test event details may be displayed in a lower portion 1206.

Test system 102 may be configured and/or configurable to support a plurality of protocols, and message formats or content types including, without limitation, one or more XML, EDIFACT, and TTY.

For XML, EDIFACT, and fixed length records, test system 102 may include a schema definition corresponding to a message syntax. For example, and without limitation, an XML schema may be used for XML messages, and custom schema definitions, in an XML format, may be used for EDIFACT and fixed-length records.

Java classes may be generated from the schema definitions as part of a build process. For XML, standard JAVA bindings or JAXB2 may be used. For EDIFACT and fixed-length records, message and records classes may be generated from custom schema definitions.

Schema definitions may be loaded at run-time to generate an in-memory representation of the schema that is able to read and write the message objects.

Low level formatting may be separated from mapping of high level message structures.

Teletype messages may be modeled as JAVA objects. Due to a lack of a format syntax definition in teletype messages, an associated message parser may be constructed in code using, for example, shared building blocks, rather than derived from a schema definition.

Test system 102 may include reusable data type definitions, or domains, for message definition, where domain refers to data modeling. A domain may define a set of valid values, or a subset of a base type such as string or integer. The base type may be used to represent a value of the domain. As an example, a domain “Name” that stands for non-empty strings with up to 50 characters may be defined, and the domain definition may be used thereafter for name fields. Besides leading to a more consistent use of data types, domains are the objects in the messaging code that convert between the representation, typically a string, of a value in the message and the Java type used in the message object.

Domains may be declared with a name, which may be used to reference the domain, the name of the base type, and additional type-dependent parameters.

In order to incorporate EDIFACT messages, machine-readable schema definitions, somewhat analogous to XML schema or ASN.1, may be generated for the syntax of EDIFACT airline messages. Test system 102 may use an XML format for the EDIFACT schema definitions, which is useful to convert the EDIFACT schema definitions to other formats (see, e.g., EdifactPadisSchema.html, EdifactApisSchema.html, and EdifactIatciSchema.html).

An XML description of an EDIFACT schema may include four sections inside of a EdifactSchema root tag, as illustrated below:

<EdifactSchema name=“PADIS” package=“com.abc.res.message.padis”>
<Domains>
...
</Domains>
<Composites>
...
</Composites>
<Segments>
...
</Segments>
<Messages>
...
</Messsages>
</EdifactSchema>

The domains section includes domain definitions, as described above. The composites section allows for defining EDIFACT composite elements. They can be referenced by their id in segment definitions which are contained in the Segments sections. The Messages section defines the message structures in terms of segments and groups of segments.

EDIFACT schema definitions may use domains to instruct the code generator and parser to use specific Java types such as integer or Date.

Exemplary XML format for parts of an EDIFACT message, in ascending order, include element, composite, segment, group, and message. Each of these parts may be represented by an XML tag of the same name. The following attributes may be used with these elements:

| Name | Description | Example |
|---|---|---|
| Name | Name of the element. The name is used as | reference- |
| | the name of the associated attribute in | number |
| | the generated Java class. Lisp-like dash | |
| | notation is converted to camel-case, | |
| | that is, “reference-number” as in the | |
| | example becomes “referenceNumber”. | |
| Id | The short id of the part in the EDIFACT | 9858 |
| | specification. For elements, this is a | |
| | number, for composite a letter followed | |
| | by three digits, for segments the three | |
| | letter code, and for messages the six | |
| | letter message id. | |
| mandatory | Boolean (“true” or “false”) indicating | True |
| | if the element may be omitted. | |
| maxRepeat | Defines how often the element may be | 9 |
| | repeated. This applies to the last | |
| | element of a segment or composite | |
| | element. | |

The smallest unit of an EDIFACT message may be an element that is represented by an Element tag. It adds two more optional attributes: type and domain:

| Name | Description |
|---|---|
| Domain | Name of domain as defined in the Domains section. |
| Type | EDIFACT type specification such as “an . . 17” for an |
| | alphanumeric string with up to 17 characters. |

The following are examples:

<Element name=“issue-date” domain=“Date” mandatory=“true” />
<Element id=“9835” name=“tag-serial-number” type=“n..16”
mandatory=“true” />
<Element id=“3215” name=“inbound-airport-of-departure” type=“a..5”
mandatory=“false” />

The “issue-date” uses a reference to the Date domain as defined in the domain example. The element is interpreted as a date using the “ddMMyy” (day, month, two-digit year) pattern and mapped to an “issueDate” attribute of type Date. The second one element is a number with up to 16 digits which will be stored as a string.

A composite element may be represented using a Composite tag containing the definitions of its child elements as Element tags. The Composite tag may not have special attributes. However, when a composite is defined in the Composites section, it may be referenced in a segment definition as an empty XML tag containing only the id attribute. If defined, the name and mandatory attributes may override the values defined in the Composites section.

The Segment may be used in the segment definition in the Segments sections, and may be used in the segment references in the message definitions. There may be multiple segment definitions with the same segment id. They may distinguished by an additional messages attribute that defines which messages the segment definition applies to.

The structure of an EDIFACT message is defined by (potentially nested) group and segment tags inside of a message tag. The following table describes exemplary attributes of a message definition.

| Name | Description |
|---|---|
| id | Id of the EDIFACT message type. Typically a 6 |
| | letter string ending on REQ for request messages |
| | and RES for response messages, e.g., ITAREQ and |
| | ITARES |
| name | Name of the message. Mainly used for |
| | documentation purposes. If not provided, the |
| | message type will be used. Our PADIS schema |
| | definition, for example, does not define any |
| | message names. |
| class | Name of the java class that represents this message |
| | definition. This is the simple class name (without |
| | the package). The class will be used instantiated |
| | when parsing a message associated with this |
| | message definition. If not provided, the class name |
| | is derived from the message name (which in trun |
| | defaults to the id). The message class may be |
| | different from the class generated by the EDIFACT |
| | code generator. This allows an application to |
| | define custom message classes that extend the |
| | generated classes. The class attribute is |
| | especially useful when using different message |
| | definitions for variations of the same message |
| | type. |
| generatedClass | Simple name of the java class to generated for this |
| | message definition. The code generated will |
| | generate a class with this name in the package |
| | specified in the root element of the schema |
| | definition. If not defined, the name defaults to |
| | the class name (which falls back to the name, which |
| | falls back to the id). |
| discriminatorPath | Path pointing to the element in the EDIFACT |
| | message that is used to distinguish variations of the |
| | same message type (same id). The path is a |
| | sequence of (segment, composite, and element) |
| | names separated by periods. Only the first |
| | message definition of a message type may have this |
| | attribute. All following message definitions of the |
| | same message type must define the |
| | discriminatorValue attribute. |
| discriminatorValue | Value of the discriminator element for this message |
| | definition. Only used in case of multiple message |
| | definitions for the same message type. The second |
| | and all following message definitions for the same |
| | message type must have this attribute. |

The airline EDIFACT specification contain a number of “multi-purpose” messages whose structure and meaning depends a lot on so-called message function defined in the first segment of the message. An example is the TKTREQ message: Depending on the message function (the second element in the MSG segment which is the first segment of the message after the standard UNH header segment), this request message describes a ticket issue (130), display (131), and void (133).

Since the structure and meaning of these messages vary, they may be represented by different message definitions and java classes. Test system 102 or an EDIFACT framework therein, may be configured to support this with discriminators to distinguish variations of the same message type.

An example is provided below.

<EdifactSchema name=“SAMPLE”
package=“com.abc.res.message.edifact.sample”>
<Domains>
<Domain name=“Date” type=“date” pattern=“ddMMyy” />
<Domain name=“TimeOfDay” type=“timeOfDay” pattern=“HHmm” />
<Domain name=“Integer” type=“integer” />
</Domains>
<Segments>
<Segment id=“MSG” name=“message-action”>
<Composite>
<Element name=“business-function” mandatory=“false” />
<Element name=“message-function” mandatory=“false” />
</Composite>
<Element name=“responsible-agency” mandatory=“false” />
</Segment>
<Segment id=“ODI” name=“origin-and-destination”>
<Element name=“origin” mandatory=“false” />
<Element name=“destination” mandatory=“false” />
</Segment>
<Segment id=“ORG” name=“originator-info”>
<Composite id=“C336” name=“deliverer” mandatory=“true”>
<Element name=“id” mandatory=“true” />
<Element name=“city” mandatory=“false” />
</Composite>
</Segment>
</Segments>
<Messages>
<Message id=“SAMREQ” discriminatorPath=“message-action.message-
function” version=“96.1-AT”>
<Segment id=“MSG” mandatory=“true” />
</Message>
<Message id=“SAMREQ” discriminatorValue=“100” class=“Samreq100”
version=“96.1-AT”>
<Segment id=“MSG” mandatory=“true” />
<Segment id=“ODI” mandatory=“false” />
</Message>
<Message id=“SAMREQ” discriminatorValue=“200” class=“Samreq200”
version=“96.1-AT”>
<Segment id=“MSG” mandatory=“true” />
<Segment id=“ORG” mandatory=“false” />
</Message>
</Messages>
</EdifactSchema>

This schema includes three message definitions for the SAMREQ (“sample request”) message type. The first one specifies which element to use to distinguish the message variations by defining a discriminatorPath attribute. The discriminator element is the message-function component inside of the anonymous composite in the message-action (MSG) segment.

The following two message definitions define two variations. When the message-function element is “100”, the Samreq100 class will be used. When this element is “200”, the Samreq200 class will be used. These generated classes will contain just the attributes defined in the respective message definition. Similarly, reading and writing will be performed according to those message definitions. The first message definition is only used to determine the discriminator value.

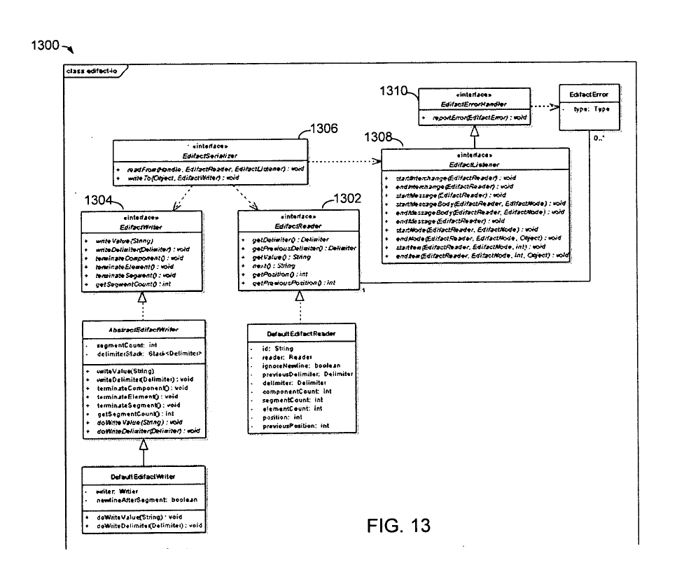

FIG. 13 illustrates exemplary interfaces for input and output of EDIFACT messages. Low-level I/O interfaces, an EdifactReader 1302, and an EdifactWriter 1304, interpret the stream of characters as a sequence of EDIFACT values and delimiters.

EdifactReader 1302 is an iterator-style interface that allows for walking from value to value in the EDIFACT stream. At each point, access is available to the value, the delimiter before and after the value, and the associated positions. In the opposite direction, EdifactWriter 1304 translates commands to write a value or end a message part into characters written to a stream. The EdifactWriter implementations take care of the rules for omitting empty values and delimiters.

An EdifactSerializer 1306 sits on top of the reader and writer interfaces and can marshal (writeTo) and unmarshall (readFrom) EDIFACT message objects. A client can track the parsing of a message through an EdifactListener interface 1308 which, as an extension of an ErrorHandler 1310, is also notified in case of errors.

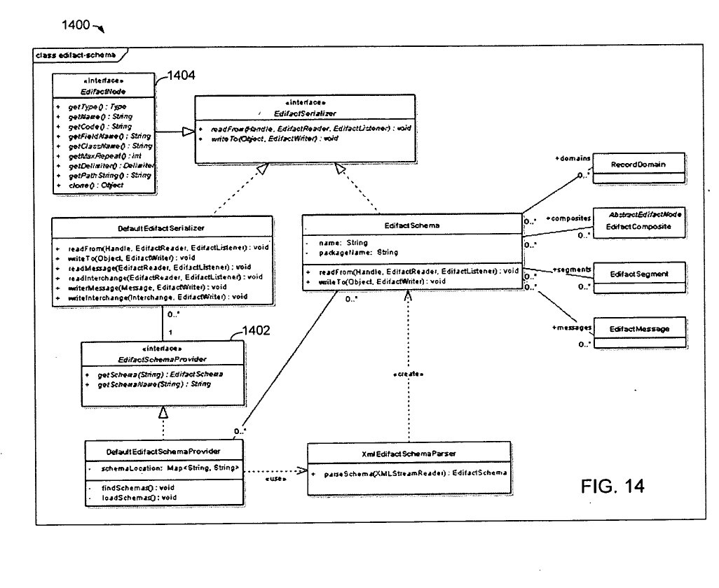

An EDIFACT schema such as the PADIS or IATCI schema, may be represented by an EdifactSchema object. It contains the objects for all the parts, composites, segments, and messages and can read and write EDIFACT messages and interchanges. FIG. 14 illustrates exemplary EDIFACT schema classes 1400 and relationships therebetween.

An application may use multiple EDIFACT schemas at the same time. They may be registered in an EdifactSchemaProvider 1402. The default implementation may look for EDIFACT schema definitions in XML format.

Each part of an EDIFACT message (component, element, composite, group, segment, and the message itself) may be implemented as an EdifactNode 1404. EdifactNodes may include value nodes and composite nodes. Value nodes may correspond to EDIFACT elements and components, that is, the parts of a message that contain the data. An EdifactValueNode base class may have a domain that converts the strings in the message to values and vice versa. Other parts may be composite nodes and may extend EdifactComposite.

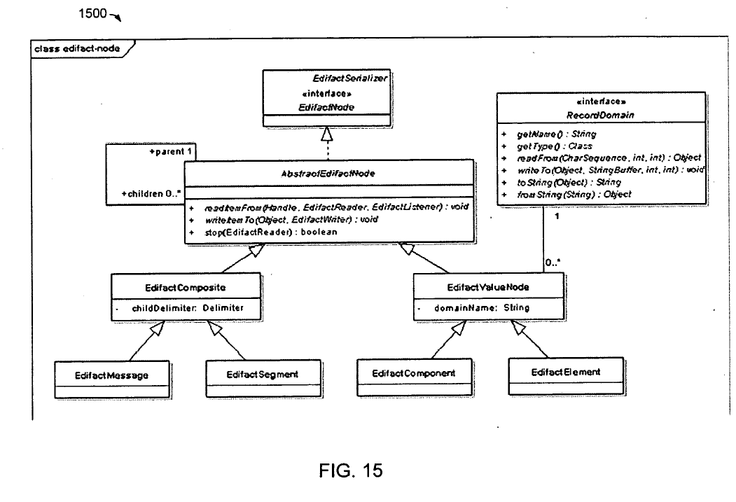

FIG. 15 is a graphic illustration of a class EDIFACT-node 1500. When parsing an EDIFACT message, a tree of EdifactNodes may be traversed while walking through the message with the EdifactReader, as illustrated in FIG. 15.

An EdifactCodeGenerator builds Java bean definitions for an EdifactSchema. It recursively traverses message definitions in the schema and collects BeanDefinitions required for named composite nodes, that is, messages, groups, segments, and composite elements. The Java bean classes are created with getters, setters, and “fluent” setters.

An external interface format may use mainframe-like fixed-length records, such as an SSIM format that describes an airline schedule. In this exemplary case, records are 200 characters long, and include five record types which can be distinguished by the first character in each record.

More generally, a fixed-length record format consists of a sequence of records, each record being of fixed length and consisting of fields of fixed length and position. The different types of records can be recognized using a tag, typically the first one or two characters in a record.

Test system 102 may be configured to support reading and writing of fixed-length record formats. A format may defined in an XML record schema definition, which may be used at compile time to generate Java classes for the record types and at run-time to map the fields in the record data to the attributes of the generated record classes.

Below is an exemplary portion an XML formatted record schema definition for an SSIM schema:

<RecordSchema name=“SSIM”
package=“com.abc.res.message.ssim.record”
recordLength=“200” tagLength=“1”>
<Domain name=“Date” type=“date” pattern=“ddMMMyy”/>
<Domain name=“TimeOfDay” type=“timeOfDay” pattern=“HHmm”/>
<Domain name=“Integer” type=“integer”/>
<Domain name=“DaysOfWeek” type=“string” trim=“false”/>
<Record name=“header” class=“HeaderRecord”
generatedClass=“HeaderRecordBase” tag=“1”>
<Field name=“recordType” start=“1” end=“1”/>
<Field name=“title” start=“2” end=“35”/>
...
</Record>
<Record name=“carrier” class=“CarrierRecord”
generatedClass=“CarrierRecordBase” tag=“2”>
<Field name=“recordType” start=“1” end=“1”/>
<Field name=“timeMode” start=“2” end=“2”/>
...
<Field name=“periodStart” start=“15” end=“21” domain=“Date”/>
<Field name=“periodEnd” start=“22” end=“28” domain=“Date”/>
...
</Record>
...
</RecordSchema>

The root element, RecordSchema, defines the (fixed) length of the records and the length of the tag. It also sets the Java package to use for the generated record classes.

The RecordSchema contains two sections: The first section defines domains to be used for the field data types. The second, main section defines the record types. Each record is defined as a Record element containing a list of Field elements. The record definition mainly defines the tag value used to recognize the record type and the names of the Java classes to be used. As for EDIFACT messages, an application can extend the generated record classes. The generatedClass attribute is used by the code generator, whereas the class attribute determines which objects are created when parsing a record.

A Field element defines a scalar field in a record. The location inside of the record is defined as in most specifications of such format using the first and last position (both being inclusive and the first character having position 1). The default type of a field is a string. If the characters in a field should be interpreted differently, a domain defined in domain section may be referenced.

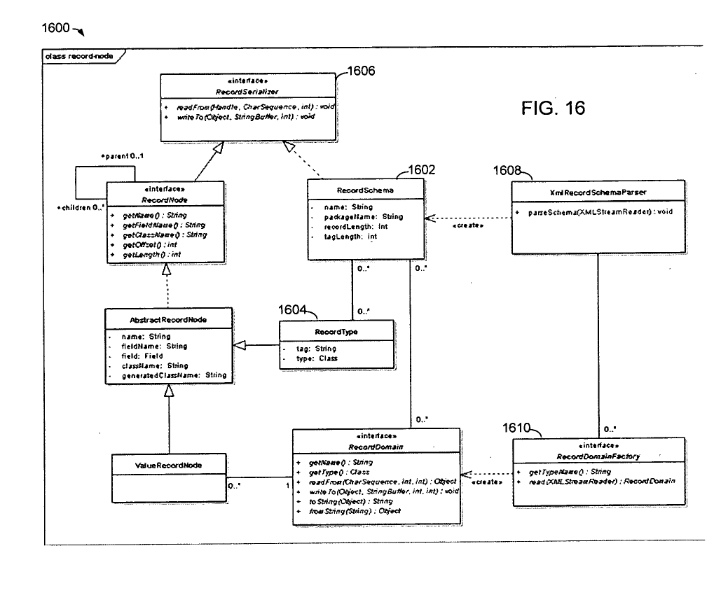

FIG. 16 illustrates exemplary classes involved in reading and writing fixed length records.

A RecordSchema 1602 describes a format of a file containing fixed length records. Each kind of record in the schema may be represented by a RecordType 1604. Both classes may implement a RecordSerializer interface 1606 that allows for reading and writing objects (the records) from “lines” (the record data). RecordType 1604 may include a list of ValueRecordNodes (via the parent/child relationship of RecordNode), one for each field in the record.

The XML record schema definition is parsed by an XmlRecordSchemaParser 1608, which may include a StAX-based parser, to walk through the schema definition and interpret a Domain definition using a set of registered RecordDomainFactorys 1610. XmlRecordSchemaParser 1608 may create a RecordType 1604 for each Record element, using the parsed domains to resolve the domain references in Field definitions.

Similar to the handling of EDIFACT messages, test system 102 may include a code generator to generating Java classes for records defined in a record schema. The code generator may be implemented in a single class. Resultant Java beans may be written to Java source files using a BeanCodeGenerator.

A variety of airline communication protocols rely on teletype (TTY) messages. In contrast to most other electronic message formats (including EDIFACT and XML), there is generally little or no format\1 syntax specification for TTY messages.

Teletype messages are plain text messages. Each message consists of a sequence of lines. Besides this separation into lines there may be no special delimiters. Spaces are in most cases optional. Each line may contain up to 69 characters. Longer lines are broken into multiple lines using continuation indicators that depend on the current context (e.g., repeating parts of the first line on all following lines).

Below is an example of an AIRIMP teletype message:

YYZRMAC
.HDQRM1A 181442/OQJOIIH41E
HDQ1A JCCQNO/ITA/5346955/BOS/1A/N/US
2CARTER/JAMES/ANDREW 1SMITH/JOHN
1DALE/PHIL
AC0888U09OCT YOWLHR SS3/1835 0625/1
AC0123Y12OCT LHRYYZ SS3/1835 0625/1
SSR INFT OS NN1 YYZLAX8315V08JUL-
1KIMMEL/MARTINDRMR.KIMMEL/BERENICEMSS08MTHS
OSI YY CTCB BOS 617-555-1212
OSI YY 1CHD KIM/SEUNG YON MISS 10 YRS

The first line contains the address the message is sent to. In this case, it is a reservation message (RM) sent to AC in Toronto (YYZ). The second line is a communication reference linking the message to a previous EDIFACT message exchange. It is one of the lines with an explicit indicator, namely the period (.) as the first character in the line. A record locator line may include multiple locators for a booking as well as information about a booking office.

Additional lines may provide the information about passengers. These lines provide an indication of the complexity of the name formatting as well as an example for a continuation line which in this case is indicated by the leading digit (the number of passengers in the following name declaration).

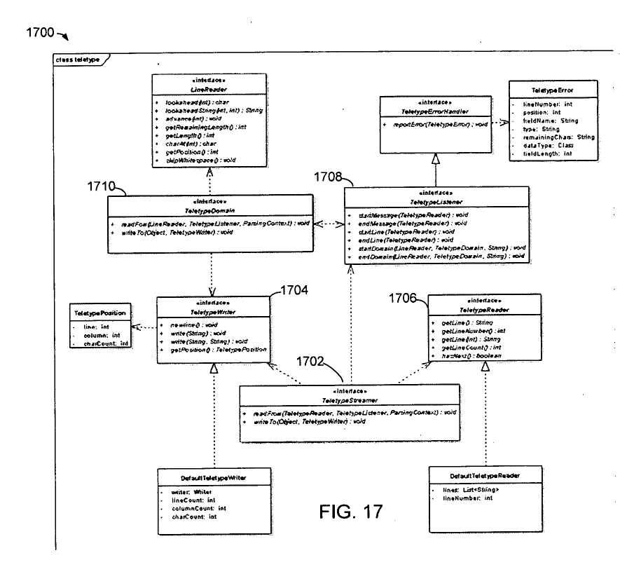

Classes for teletype messages may be coded manually based on re-usable building blocks for the message parts. FIG. 17 illustrates exemplary class teletype interfaces.

Test system 102 may include a TeletypeStreamer interface 1702 for Teletype messages, which may uses a TeletypeWriter 1704 to write message data and a TeletypeReader 1706 to write messages. While parsing a Teletype message, TeletypeStreamer 1702 may inform a TeletypeListener 1708 of progress, which may include errors that are encountered while parsing a message.

TeletypeDomains 1710 may be used to read and write individual pieces of a Teletype message such as airline codes, names, or dates. TeletypeDomains 1710 may serve as primary main building blocks when constructing a new TeletypeStreamer 1702.

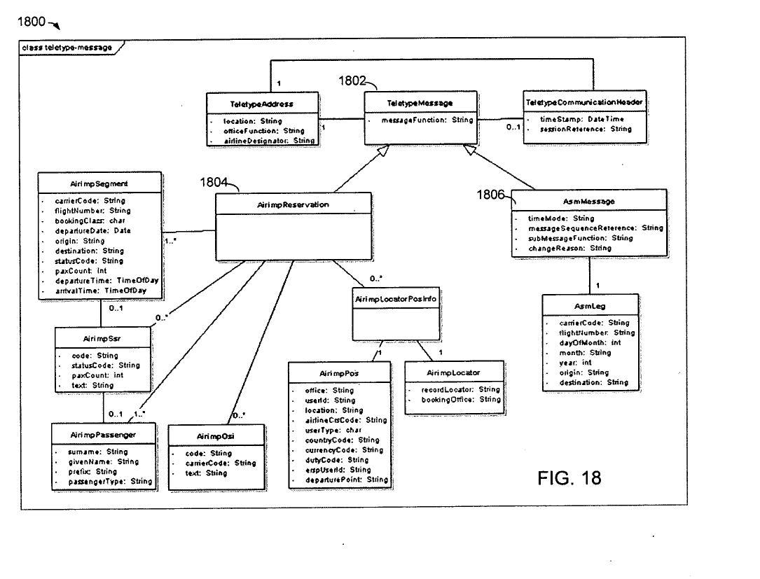

A supported Teletype message may be implemented as a custom class derived from a TeletypeMessage FIG. 18 illustrates an exemplary class teletype-message 1800, including a TeletypeMessage 1802. The example of FIG. 18 further includes an exemplary AirimpReservation 1804 and an exemplary AsmMessage 1806. AirimpReservation 1804 may represent a complete reservation and therefore may have a relatively large amount of internal structure, whereas an ASM schedule change message AsmMessage 1806 may be relatively less complex.

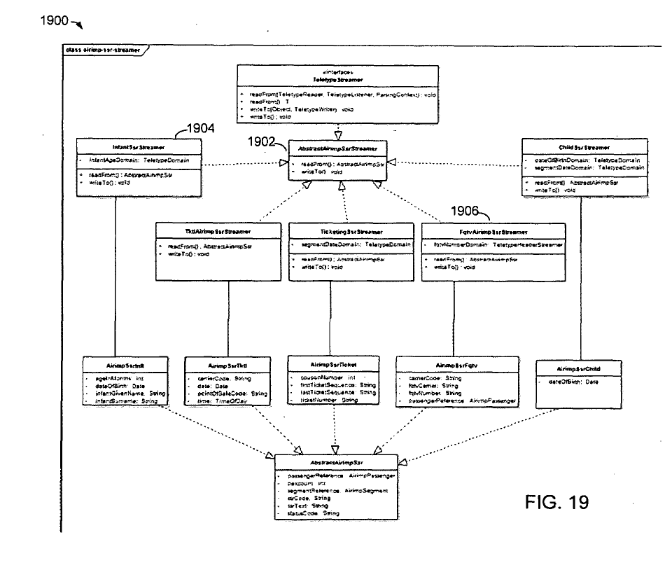

A streamer class may include logic to parse a type of message line derived from AbstractAirimpSsrStreamer. FIG. 19 is a graphic illustration of an exemplary class AIRIMP ssr-streamer 1902, including an InfantSsrStreamer 1904 and a FqtvAirimpSsrStreamer 1906.

Test system 102 may be configured with one or more automated user interface tests, which may include one or more of an Internet Explorer browser, and a XUL-based application, and ACO/ADO websites using a Firefox browser available from Mozilla organization. A JSSH plugin may be used to connect to a browser and to send javascript commands to it, for example, to access a node in the HTML document using the HTML document object model (DOM) and/or to click and set elements on pages. An exemplary JSSH plugin for Firefox is available at http://code.google.com/p/firewatir/downloads/list.

The JSSH plugin is essentially a telnet shell, allowing one to connect to the browser using a telnet localhost. Once connected, javascript commands may be sent to the shell to control the browser.

When a new connection is opened to the browser, one or more files containing javascript functions may be sent, for actions such as retrieving flight information and convenience functions, at various times during a session.

Along with DOM interaction, browser interaction may include, without limitation, waiting for a current page to render in the browser, waiting for the browser to download content from a server, waiting until a page contains a specific string. Browser action may be set to time out after a period of time, such as 30 seconds, by triggering an exception.

To provide a level of abstraction to the test developers, pages may be modeled in a fashion similar to a Java bean, where a page can be instantiated and data can be “get” and “set” on the page. The following is an example:

public void setOrigin(String origin) throws NoValueFoundException {
client.setElement(“input”, “id”, “rtOrigin”, origin);
}

In the example above, testing of the page involves an origin field to be set, which can take a string. A developer testing this page does not need to know details of the DOM, the element being set, or the browser interaction. The page builder takes care of the field constants with the base class conducting appropriate browser interaction.

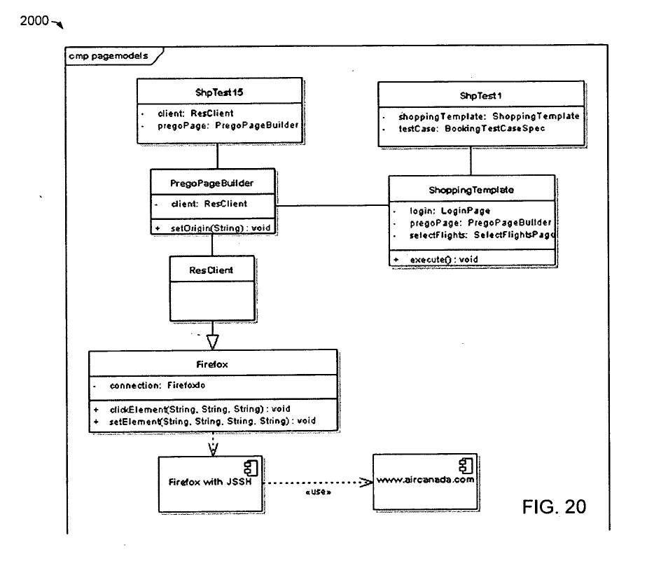

FIG. 20 illustrates an exemplary page model design 2000. In some situations, such as dynamically generated IDs on elements which cannot be referenced, or where a suitable level of abstraction is not available, pages may be modeled dynamically. An example such situation is a “Select a flight” page, where a user is presented with flight options and fare types. Such a page may be modeled dynamically, since some fare types may not be available, depending on current inventory availability.

Referring back to FIG. 4, one or more of AISUT 104, test driver 302, and simulator 304 may be configured to perform functions with respect to reservations or passenger name records (PNRs), and may be configured to adhere to standards followed by AIS, including ARSs and GDSs. A reservation may be related to multiple passengers having a common itinerary.

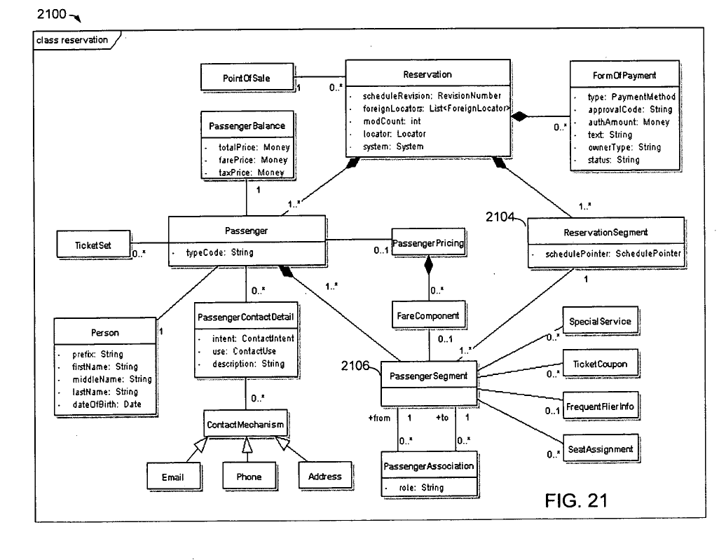

FIG. 21 is a class model diagram of an exemplary reservation class model 2100, illustrating a relationship between a reservation 2102, ReservationSegments 2104, and PassengerSegments 2106.

A reservation may include one or more segments, also referred to as a booked itinerary, and passenger identification information. A segment may include an identification of a flight segment, which may include a key such as a flight designator, a departure date, an origin, and a destination. A segment may also include a schedule version. Passenger information may include passenger name and contact information. Where a reservation includes multiple passengers and multiple segments, passengers' information may be linked to each segment through passenger segments. Passenger segment may include information associated with seating and special services.

Reservation records for multiple simulated AISs 406, and/or for AISUT 104, may be maintained in a common data repository or separate data repositories. Reservation records may include one or more attributes to identify a simulated AIS 108 or AISUT 108 for which the reservation is stored.

One or more of test driver 302, simulator 304, and AISUT 104, may be configured to store price information, and may be configured to store price information relationally with respect to one or more of passengers and fare components.

One or more of test driver 302, simulator 304, and AISUT 104 may be configured to store ticket information.

One or more of test driver 302, simulator 304, and AISUT 104 may be configured to store special services.

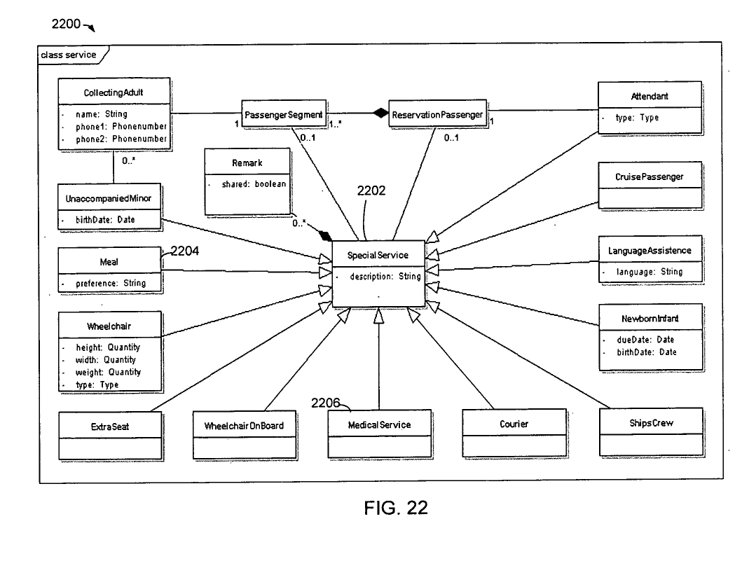

FIG. 22 is a class model diagram of an exemplary SpecialService class model 2200, illustrating exemplary special services (SSRs) that may be mapped to one or more subclasses of a SpecialService base class 2202. Classes may be mapped to one or more tables, such as in a database, using a single table for the main class hierarchy. The example of FIG. 22 includes, among other base classes, a Meal base class 2204 and a MedicalService base class 2206.

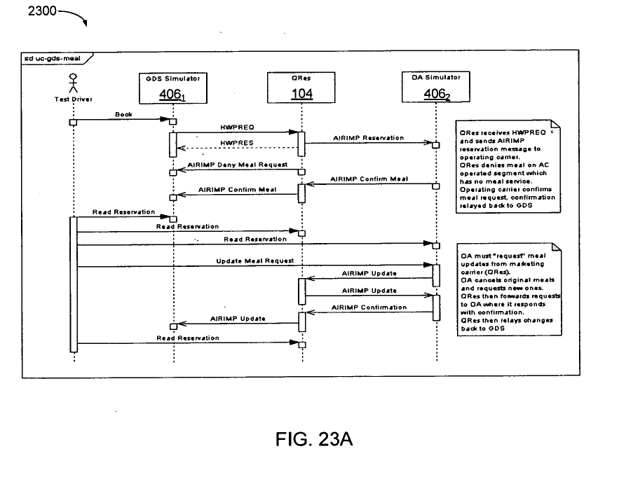

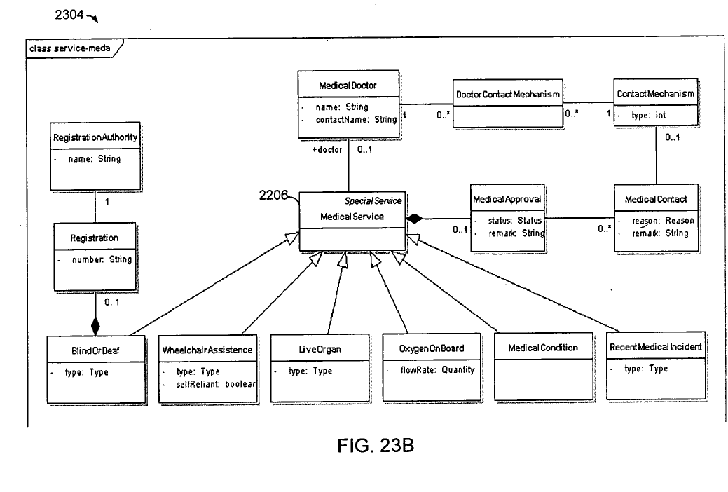

FIG. 23A is a graphic illustration of an exemplary meal service process 2302 between a simulated GDS 406₁, a reservation system within AISUT 104, and a simulated partner AIS 406₂.

FIG. 23B is a class model diagram of an exemplary medical service class model 2304, including exemplary medical services that may be mapped to one or more subclasses of MedicalService base class 2406.

Exemplary processing of messages within simulator 304 is described below.

Simulator 304 may be configured to process messages through a hierarchy of processing levels or layers, each configured to handle a corresponding aspect of message processing and to hide the details from other levels. A servlet API, for example, may be handled by a SimulatorHttpRequestHandler, and corresponding servlet request and response objects may be hidden or unavailable to other classes of a message processing chain. Similarly, RequestHandler implementations may be configured to convert between raw messages (bytes or characters) and message objects. Other handlers further down the processing chain may work with these objects.

Simulator 304 may include handlers and rules, and logic to identify the handlers and rules for appropriate tasks. Simulator 304 may be configured to look up handlers and rules using various criteria, which may include message headers and message types, and to delegate further processing in accordance with the identified handlers and rules.

Simulator 304 may include logic to represent AISs as travel systems or objects corresponding, which may be individually configurable to permit different implementations for different AISs. Simulator 304 may configured to obtain handlers from the travels systems during message processing.

Simulator 304 may be configured to receive messages over one or more transport protocol interfaces which may include one or more of an HTTP interface, an HTH interface, and a BATAP over MAITP interface.

Where an airline transport protocol is used, direct calls may be performed between systems hosted on simulator 304.

Simulator 304 may include one or more request handlers configured to handle messages received over one or more transport protocol interfaces, including multiple message content types.

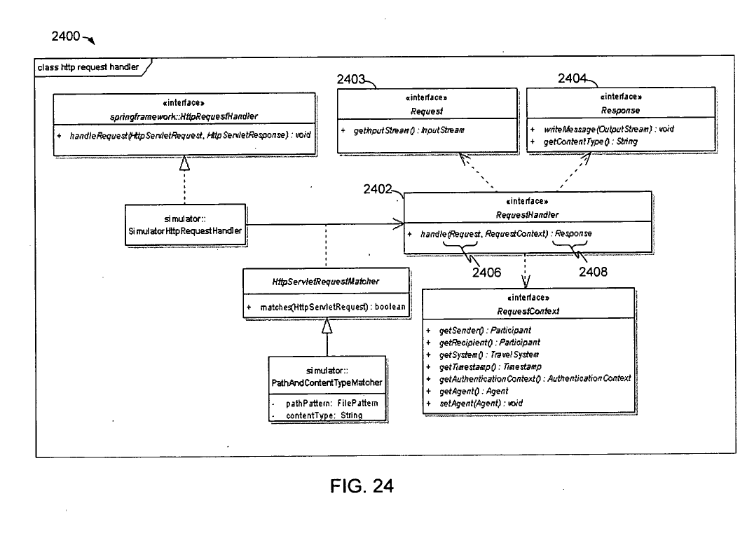

FIG. 24 is a model diagram of an exemplary HTTP request handler model 2400. A RequestHandler interface 2402 may include or invoke a method to take request information 2403 and return a response 2404. Note that, in contrast to a servlet API, response 2404 may include a return value rather than a parameter. This may serve to indicate where the response is generated. Whereas with a response parameter approach, the response logic may be spread over multiple locations.

Data associated with a request may be separated into two objects, including a Request object 2406 and a RequestContext 2408. Request object 2406 may include raw data, access to which may be limited to a top level handler. RequestContext 2408 may be passed through one or more subsequent processes.

RequestContext 2408 may include an identification of a recipient TravelSystem object corresponding to a simulated AIS 406 (FIG. 4), to which a corresponding message is directed. An identification of a TravelSystem object may be used in processing the corresponding message.

RequestContext 2408 may include an identification of an AuthenticationContext, which may be used to manage authenticated principals that are used to decide which operations are permitted.

RequestContext 2408 may include a processing timestamp and versions, which may be used to determine a snapshot of data to be used while processing the corresponding message. Where reference data is versioned and effective-dated, this may permit processing of a message with respect to appropriate data.

As a message is processed through simulator 304, the representation of Request object 2406 may change from raw data to one or more message objects or portions thereof, while RequestContext 2408 may remain constant.

Exemplary processing of messages received over an HTTP transport protocol is described below.

Simulator 304 may include an HTTP request handler to receive messages over an HTTP transport protocol interface. An HTTP request handler class may include and/or implement a Spring HttpRequestHandler, and may be configured to receive a raw servlet request and to generate a response. An HTTP request handler may include a Spring bean configured in a Spring application context, and may be associated with other objects to be used in processing of the request, such as a TravelSystemHost, described below.

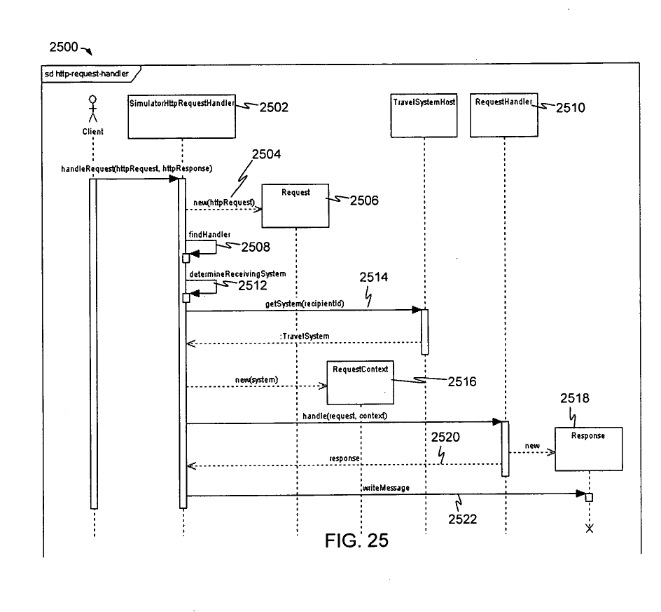

FIG. 25 is a graphical illustration of an exemplary HTTP request handler model 2500, including a SimulatorHttpRequestHandler 2502.

SimulatorHttpRequestHandler 2502 may be configured to hide the servlet API from the other portions of the processing chain and to dispatch a corresponding abstract request to a suitable RequestHandler, described below.

When a corresponding handleRequest method is called, SimulatorHttpRequestHandler 2502 generates a generic Request 2506 for an incoming HTTP message 2504. Depending on the log level, message 2504 (including its body) may be logged at this point. At 2508, a RequestHandler 2510 is identified, as being associated with a corresponding HTTP path and content type. RequestHandler 2510 may be selected from a plurality of RequestHandlers, which may include one or more of an XML, an EDIFACT, and a Teletype RequestHandler.

At 2512, a determination is made as to which simulated AIS 304 message 2504 is directed, referred to herein as a recipient AIS or recipient TravelSystem object. The recipient AIS 304 may be identified from meta data or information of message 2506, which may be stored in a header, such as a custom header. At 2514 the corresponding TravelSystem object is obtained. The TravelSystem object may be obtained from a TravelSystemHost, configured to act an entry point to TravelSystem objects.

A RequestContext 2516 may be configured to include the TravelSystem object.

Further processing of request 2506 may be delegated to RequestHandler 2510. Upon completion of processing of request 2506, RequestHandler 2510 may construct a response 2518 and return it to SimulatorHttpRequestHandler 2502 at 2520, which may write response 2518 to an HTTP output stream at 2522.

In the example of FIG. 25, SimulatorHttpRequestHandler 2502 handles selection of RequestHandler 2510 depending upon content type (e.g., XML, EDIFACT, and Teletype). Parsing and processing of contents of message 2504 is delegated to RequestHandler 2510, which may delegate to one or more message handlers.

Simulator 304 may include one or more of an EdifactRequestHandler, an XmlRequestHandler, and a TeletypeRequestHandler, which may be configured to parse corresponding content type messages using content type specific parsers.

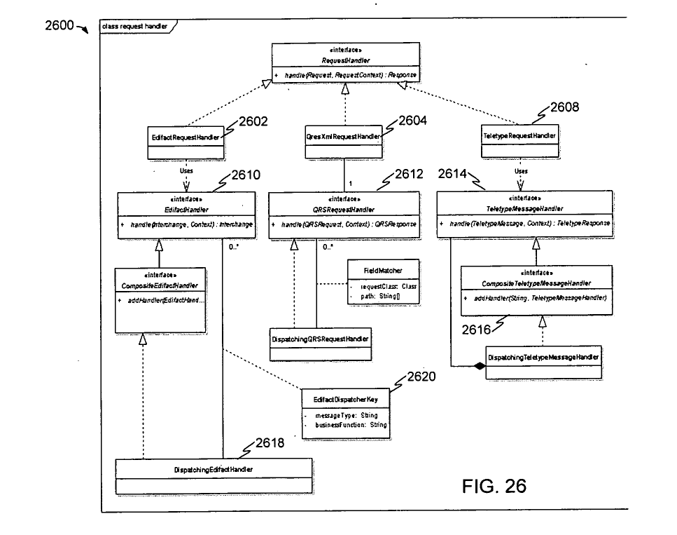

FIG. 26 is a graphic illustration of exemplary request handlers, including an EdifactRequestHandler 2602, an XMLRequestHandler 2604, and a TeletypeRequestHandler 2606. EdifactRequestHandler 2602 may be configured to use a schema-based EDIFACT framework, such as described above. XmlRequestHandler 2604 may be configured to use JAXB based on an XML schema, such as described above. TeletypeRequestHandler 2606 may be configured to use hand-coded teletype streamers, such as described above. Request handlers 2602, 2604, and 2606 may be configured to parse message contents.

Processing of parsed contents may be delegated to one or more content type message handlers to process contents of messages, such as request 2506 in FIG. 25. Content type message handlers may include one or more of an XML message handler, an EDIFACT message handler, and a TTY message handler.

A content type message handler may include a content type handle interface configured to take a parsed request message as a first argument. Content type message handler interfaces may be configured to dispatch messages, such as request 2506 in FIG. 25, to an appropriate content type message handler. In the example of FIG. 26, simulator 304 includes an EdifactMessageHandler interface 2610, an XMLMessageHandler interface 2614, and a TeletypeMessageHandler interface 2614.

Content type message handler interfaces 2610, 2612, and 2614 may be configured to take parsed request message as a first argument. For example, EdifactRequestHandler 2602 may be configured to take an EDIFACT Interchange. XMLRequestHandler 2604 may be configured to take a base class XMLRequestBase of XML requests. TeletypeMessageHandler 2608 may be configured to take a base class TeletypeMessage of teletype message objects.

Exemplary handling of teletype messages is described below.

Teletype messages may be processed by a TeletypeRequestHandler configured to store and parse contents of teletypes message. Processing of the parsed contents may be delegated to a TeletypeMessageHandler.

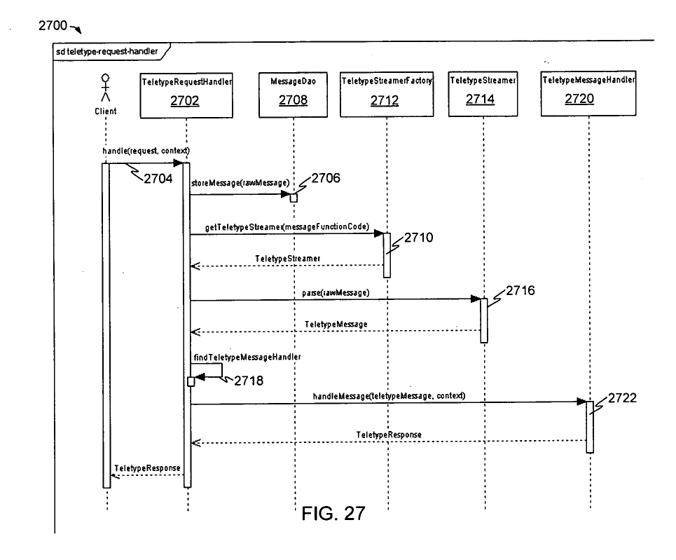

FIG. 27 is a graphic illustration of teletype request handler model 2700, including a TeletypeMessageHandler 2702. A corresponding handle method obtains an abstract Request 2704, including a raw teletype message and corresponding RequestContext. At 2706 the raw message is stored using a MessageDao 2708. The stored raw message may be accessed by a test such as with a message capture web service.

Conversion of the parsed message to a TeletypeMessage is described below.

At 2710, TeletypeRequestHandler 2702 obtains a TeletypeStreamer 2714 from TeletypeStreamerFactory 2712. This may be performed in response to message function code within the teletype message. Alternatively, this may be performed with respect to AIRIMP. At 2716, TeletypeStreamer 2714 converts the raw message data to a TeletypeMessage object.

Processing of the TeletypeMessage object may depend upon one or more parameter associated with recipient TravelSystem, which may depend upon a corresponding message sender or message originator. For example, different sender systems may require different behavior in the receiving system.

At 2718, a TeletypeMessageHandler 2720 may be identified with respect to the recipient TravelSystem. This may include asking the recipient TravelSystem for a TeletypeMessageHandler that can process teletype messages coming from the message sender. At 2722, processing of the TeletypeMessage may be delegated to TeletypeMessageHandler 2720.

TeletypeMessageHandler 2720 may be configured to delegate processing of the TeletypeMessage to one or more functional message handlers configured to process a corresponding type of request such as an AIRIMP reservation request, an MVT, or a DIV. In FIG. 26, a DispatchingTeletypeMessageHandler 2616 may be configured to dispatch the TeletypeMessage to a functional message handler based on message function code. Exemplary functional message handlers are described further below.

EDIFACT messages may be processed similar to that described above with respect to teletype message. Processing of EDIFACT messages may include generate response messages.

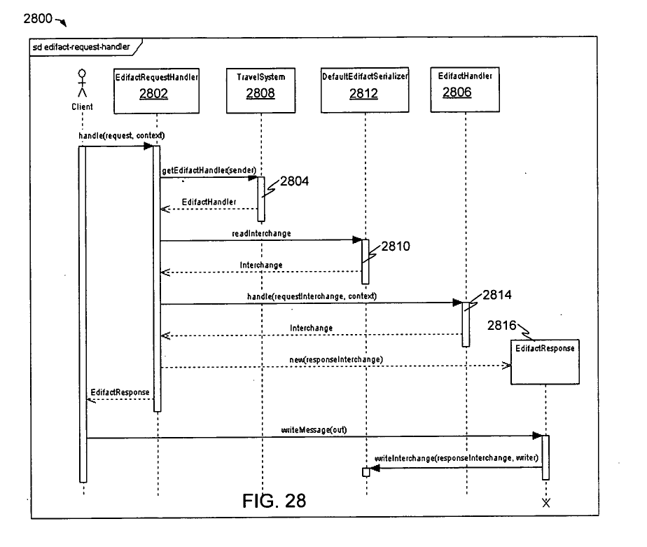

FIG. 28 is a graphic illustration of an EDIFACT request handler function 2800, including an EdifactRequestHandler 2802.

At 2804 an EdifactHandler 2806 may be obtained from a TravelSystem 2808. An identification of a corresponding message originator may be provided to TravelSystem 2808.

At 2810, the EDIFACT message or interchange is parsed. An EDIFACT message may include meta-information to find the schema corresponding to the EDIFACT message. The message may be parsed by a DefaultEdifactSerializer 2812 that knows the EDIFACT schemas supported by simulator 304.

At 2814 the parsed EDIFACT message is handled by EdifactHandler 2806, which may generate an EdifactResponse message or interchange object 2816. EdifactResponse 2816 may be serialized. The serialization may be delayed until a client request. A client request may include a call to a writeMessage method on EdifactResponse 2816. For HTTP, this may include writing EdifactResponse 2816 to an HTTP response stream.

EdifactHandler 2806 may be configured as a dispatching handler to use a DispatchingEdifactHandler class 2618 in FIG. 26.

An EDIFACT message may be dispatched with respect to a message property, such as an EDIFACT message type, which may be a six character string, and which may include one or more of ITAREQ and TKCREQ. Dispatching may also be performed with respect to one or more message discriminators within an EDIFACT framework. This may be useful, for example, where EDIFACT messages of a same type are used for multiple purposes depending upon other information inside the messages. Message discriminators may permit dispatching of EDIFACT messages based on message type and message function, such as may be contained within a message action segment (MSG). These two properties of a message may be included within an EdifactDispatcherKey 2620 (FIG. 26), which may be used to register and look up EdifactHandlers in DispatchingEdifactHandler 2618.

XML messages may be handled similarly to that described above with respect to handling of EDIFACT requests. XML messages may be serialized under control of JAXB.

XML reservation requests may be used by simulator 304 to drive tests and to query a state simulator 304. Where JAXB-compliant XML schema is available, other XML requests can be handled in a similar fashion, which may include one or more additional handler classes.

An XmlRequestHandler may be configured to handle all or substantially all XML messages or requests.

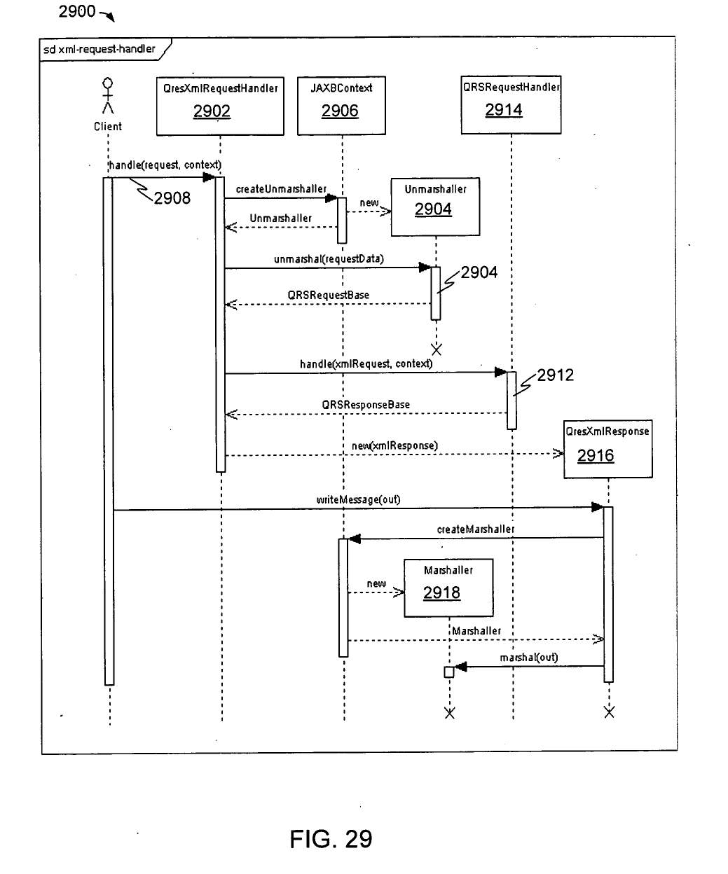

FIG. 29 is a graphic illustration of an exemplary XmlRequestHandler environment 2900, including an XmlRequestHandler 2902.

An Unmarshaller 2904, which may include a JAXB Unmarshaller, may be obtained from a JAXBContext 2906, to convert a raw XML request 2908 to a QRSRequestBase object at 2910. At 2912, the QRSRequestBase object is passed to a handle method of a QRSRequestHandler 2914, which returns an XML QRSResponseBase object. The XML QRSResponseBase object may be wrapped in a generic response object, illustrated here as a QresXmlResponse 2916, that can be used by a client to write the XML message to an output stream. When a writeMessage method of QresXmlResponse 2916 is called, QresXmlResponse 2916 may obtain a Marshaller 2918 from JAXBContext 2906 to serialize the XML response object.

QRSRequestHandler 2914 may include or may be configured as a DispatchingQRSRequestHandler.

XML messages may not include a message type. An XML API may be configured to use a verb-noun schema to organize XML requests. A reservation request root element may include an envelope, which may be similar to a SOAP envelope, and which may include a header and a list of possible child elements for various operations such as read and create. Such top-level child elements may serve as verbs. Child elements may serve to identify corresponding requested operations. Each top-level operation element may include one of a plurality of child elements representing a kind of object to operate on, such as a reservation or agent. Such second-level child elements may serve as nouns.

A DispatchingQRSRequestHandler may be configured to utilize paths in a request object to determine whether a handler is applicable. Matching logic may be encapsulated in a FieldMatcher class. Given a class and a path, or an array of field names, a FieldMatcher checks whether a request object includes data in the field identified by the path. The path in a FieldMatcher may correspond to an element-only XPath expression.

A FieldMatcher may be configured to utilize reflection to navigate request objects. Where lookup of Field objects is expensive, Field objects may be cached in FieldMatcher objects.

Exemplary travel systems are now described.

Simulator 304 may be configured to represent AISs 406 as TravelSystems or TravelSystem objects. A TravelSystem may serve as an entry point for functionality provided by simulator 304.

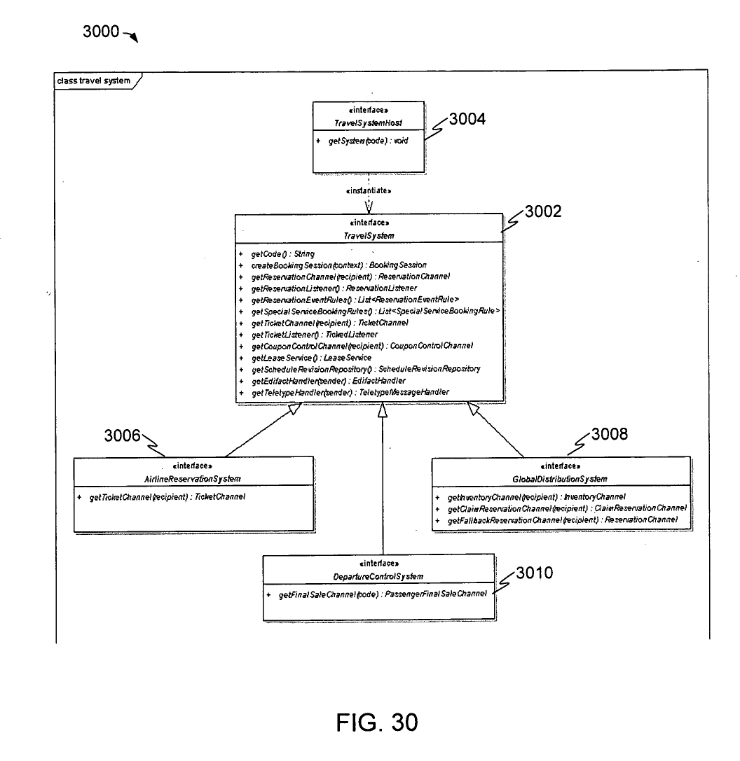

FIG. 30 is a graphic illustration of a travel system environment 3000, including a TravelSystem 3002. Simulator 304 may include one or more of a plurality of interfaces to TravelSystem 3002, which may include one or more of a TravelSystemHost interface 3004, an AirlineReservationSystem interface 3006, a GobalDistributionSystem interface 3008, and a DepartureControlSystem interface 3010.

Simulator 304 may be configured to process received messages using handlers and sessions, and to prepare outgoing messages or notifications using channels and rules. TravelSystems may include or may be associated with parameters and/or processing rules, which may include handlers, that enable simulator 304 to simulate features that may be unique to a recipient AIS and/or to a message sending AIS.

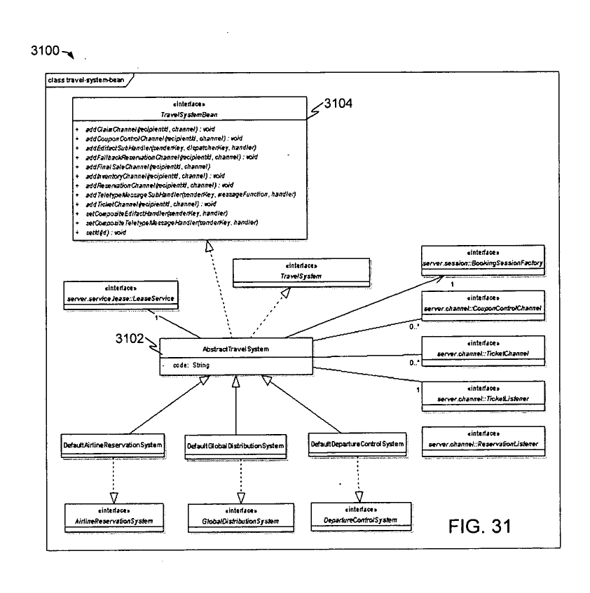

TravelSystems may be configured to manage various objects such as handlers and channels that provide functionality. Management, or a portion thereof, may be implemented with a single implementation, referred to as an AbstractTravelSystem. FIG. 31 is a graphic illustration of a travel system environment 3100, including an AbstractTravelSystem 3102, which may be extended as illustrated in FIG. 31.

TravelSystems may be implemented and configured individually for each AIS.

Alternatively, or additionally, differences between AISs may be modeled in configuration data. In the example of FIG. 31, differences may be modeled using a TravelSystemBean interface 3104, which may include setters to model differences. TravelSystems may be instantiated as Spring beans, and methods corresponding to TravelSystemBean interface 3104 may include setter-like methods, or setters and add methods.

Exemplary handling of booking messages or requests is now described. The term “booking,” as used herein, may refer to one or more functions associated with creating and/or modifying of airline reservation information.

Simulator 304 may include content type logic for each of a plurality of content types, to process booking requests associated with all or substantially all travel systems.

Simulator 304 may be configured to receive booking messages or requests through one or more request channels, which may include one or more of an XML channel, an EDIFACT channel, and an AIRIMP channel.

A booking operation may initiate changes to a reservation entity and/or associated objects, together referred to herein as a domain model. In response, one or more other systems, which may include one or more simulated AISs 406 and/or AISUT 102, may need to be notified. Notification may include sending information regarding the changes as EDIFACT and/or AIRIMP messages. Notification requirements may vary depending on the parameters and/or rules associated with a corresponding recipient simulated AIS 406.

Simulator 304 may include booking logic that is configured to be used across multiple request types, which may include one or more of XML, EDIFACT, and AIRIMP. Booking logic and request handling logic may be relatively independent or decoupled from one another. Similarly, booking logic and domain models may be relatively independent or decoupled from notification logic.

Simulator 304 may be configured to initiate sessions to mediate between request handling, domain models, and listeners that may augment the main domain logic with additional functionality such as messaging.

Simulator 304 may include a notification mechanism configured to interface between sessions and messaging logic.

Sessions may be configured to collect changes performed on domain objects as ReservationEvents, which may be sent to ReservationListener configured to perform functions in response to a reservation change, such as messaging another system.

A ReservationListener may be configured to utilize ReservationChannels and ReservationActionRule to determine which additional operation to perform and how to inform other systems.

A session may be implemented as a stateful object that exists for the duration of a request. A session may know or be associated with a corresponding domain model and with service and data access objects that help to perform booking operations. A session may not know or be associated with the request objects used in the various transfer protocol channels, and may not know or be associated with actions performed by a corresponding ReservationListener.

A booking request may involve multiple reservations. A “divide”, for example, may split an existing reservation into two reservations.

Sessions may include BookingSessions and ReservationSessions. A BookingSession may be used as an umbrella for all operations in a booking request. A separate ReservationSession may be used operations on each reservation. Specialized session interfaces may be used for groups and re-accommodations.

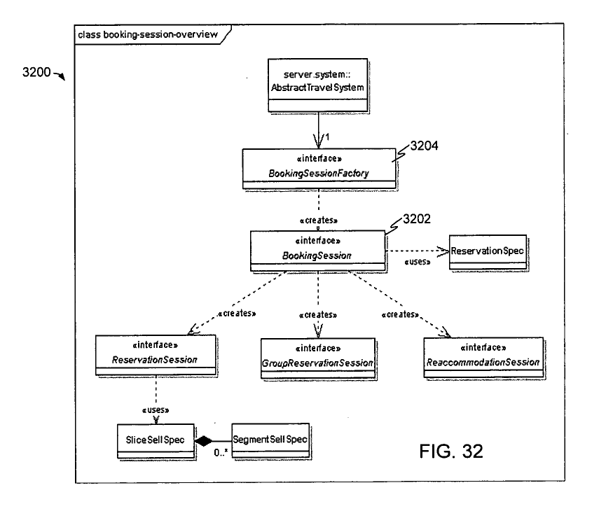

FIG. 32 is a graphic illustration of a booking session environment 3200. A BookingSession 3202 may be obtained from a recipient TravelSystem. A default implementation encoded in an AbstractTravelSystem 3204 may use a BookingSessionFactory 3206 to create BookingSession 3202.

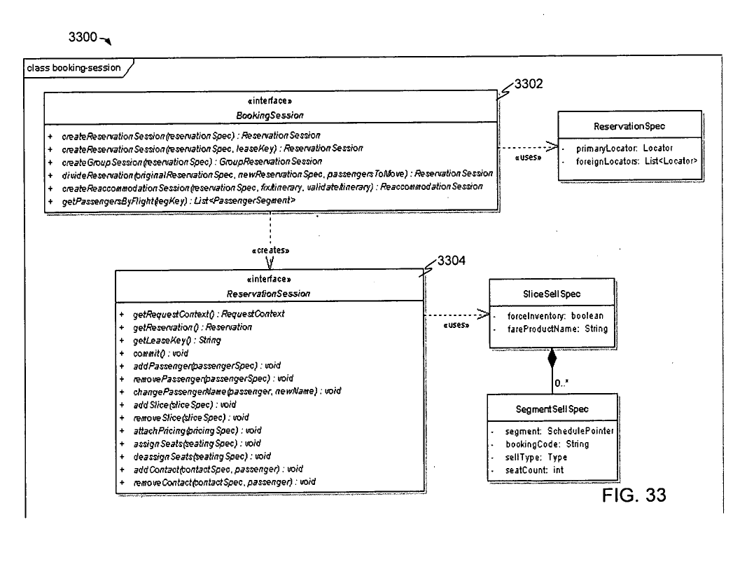

Booking requests associated with different request content types, such as AIRIMP, EDIFACT, and XML, may follow similar patterns or sequence of commands to create and/or modify reservations. Handlers for booking requests translate the commands into calls to matching methods of the corresponding session objects. FIG. 33 is a graphic illustration of an exemplary booking and reservation session environment 3300, including a BookingSession 3302 and ReservationSession 3304.

BookingSession 3302 creates or retrieves reservations and returns them wrapped in ReservationSession 3304. Reservation operations may be performed on ReservationSession.

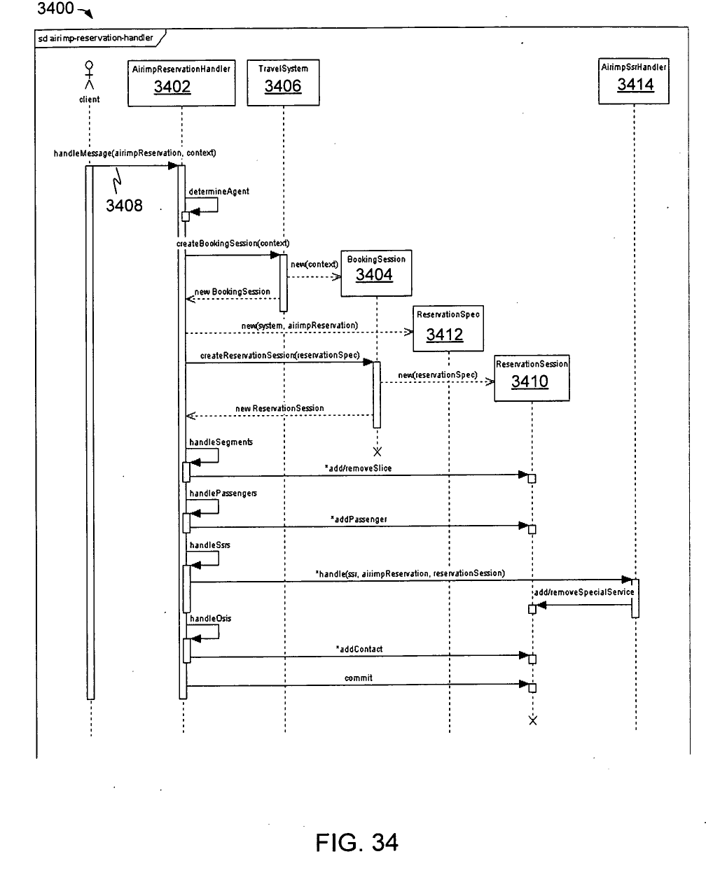

For example, FIG. 34 is a graphic illustration of an ARIMP reservation message environment 3400, including booking and reservation sessions for an AIRIMP booking message.

In the example of FIG. 34, an AirimpReservationHandler 3402 obtains a BookingSession 3404 from a TravelSystem 3406 corresponding to a recipient AIS 406 (FIG. 4) that received a corresponding AIRIMP message 3408. The AIRIMP reservation message 3408 may include instructions for a single reservation and AirimpReservationHandler 3402 may request a single ReservationSession 3410 from BookingSession 3404. A ReservationSpec 3412 may include locators from AIRIMP message 3408.

AirimpReservationHandler 3402 may process segments, passengers, SSRs, and OSIs contained in AIRIMP message 3408, in association with ReservationSession 3410. For each of these pieces, AirimpReservationHandler 3402 calls associated methods on ReservationSession 3410. Where AIRIMP message 3408 includes an SSR, translation of the SSR to a special service object may be delegated to an AirimpSsrHandler 3414 that is selected by SSR code.

After handling of instructions contained in AIRIMP request 3408, AirimpReservationHandler 3402 may call a commit method on ReservationSession 3410 to cause ReservationSession 3410 to notify listeners of reservation changes.

Exemplary operation and implementations of BookingSession and ReservationSession, operations on domain models, and management of service dependencies, such as inventory, are described below.

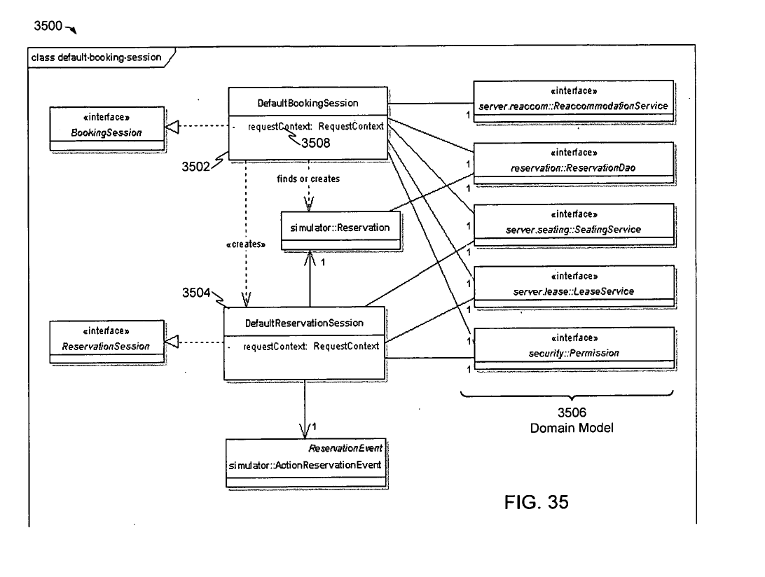

FIG. 35 is a graphic illustration of a default booking and reservation session environment 3500, including a DefaultBookingSession 3502 and a DefaultReservationSession 3504. FIG. 35 illustrates exemplary default session implementations in a context of service and data access objects used to perform operations on a domain model 3506.

A BookingSession may be a stateful object associated with a request. In the example of FIG. 35, this is illustrated with a RequestContext attribute 3508 in DefaultBookingSession 3502. Other associations may link DefaultBookingSession 3502 to one or more stateless service and/or data access objects, which may include one or more of a ReservationDao to find and save reservations, a LeaseService to provide access to inventory that has been temporarily held or leased prior to a booking, and a Permission to authorize booking operations based on a current AuthenticationContext within RequestContext 3508.

For example, when a ReservationSession is requested, a DefaultBookingSession may use a ReservationDao to find a corresponding Reservation, or may create a Reservation. The Reservation may be returned and wrapped into a DefaultReservationSession. This class may acquire services from the DefaultBookingSession.

A DefaultReservationSession may be linked to a single reservation, and a corresponding ActionReservationEvent may track operations performed on the reservation. The ActionReservationEvent may be provided to listeners to notify other systems of changes.

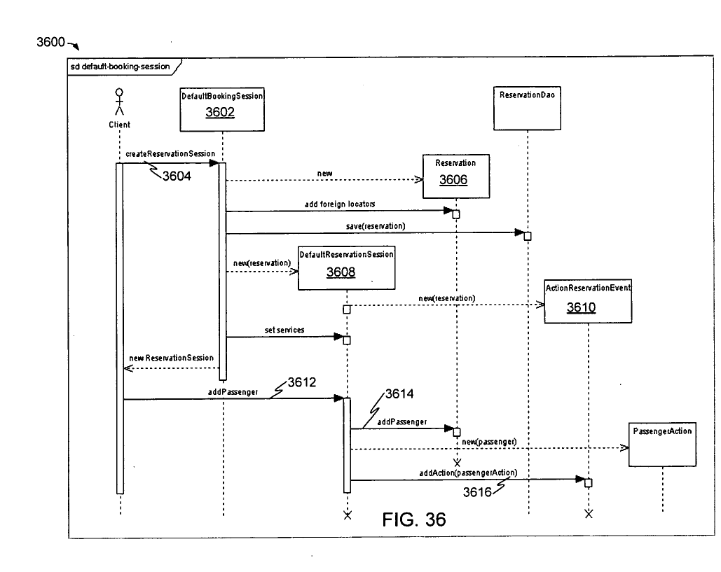

FIG. 36 is a graphic illustration of an exemplary reservation session environment 3600, including a DefaultBookingSession 3602. The example of FIG. 36 illustrates exemplary operations to add a passenger.

At 3604, a call to createReservationSession is made. If a reservation does not currently exist, DefaultBookingSession 3602 creates and saves a new Reservation 3606. DefaultBookingSession 3602 then prepares a DefaultReservationSession 3608 for Reservation 3606. Preparation of DefaultReservationSession 3608 may include creating a new ActionReservationEvent 3610 to track actions performed on Reservation 3606.

At 3612, a call to addPassenger is performed in DefaultReservationSession 3608. This may include adding a passenger to Reservation 3606 at 3614, and may include creating an associated action object and adding it to ActionReservationEvent 3610 at 3616.

Processing of a booking request may result in a change or modification to a corresponding reservation and/or associated constituents, together referred to as a domain object. Changes may be captured with ReservationEvents, substantially independent of the corresponding request object.

Simulator 304 may be configured to perform one or more actions with respect to ReservationEvents, which actions may include one or more of notifying other AISs, storing auditing information, and sending a message to a customer. Such actions may very depending on the recipient AIS or TravelSystem and/or on a system to be notified.

Simulator 304 may include a ReservationListener configured to perform or initiate such subsequent actions in response to ReservationEvents, and with respect to parameters and/or rules associated with corresponding TravelSystems. For example, an outgoing AIRIMP message may be generated to notify another system of all changes to a reservation. By collecting changes resulting from a request in a ReservationEvent, ReservationListener may be configured as stateless objects.

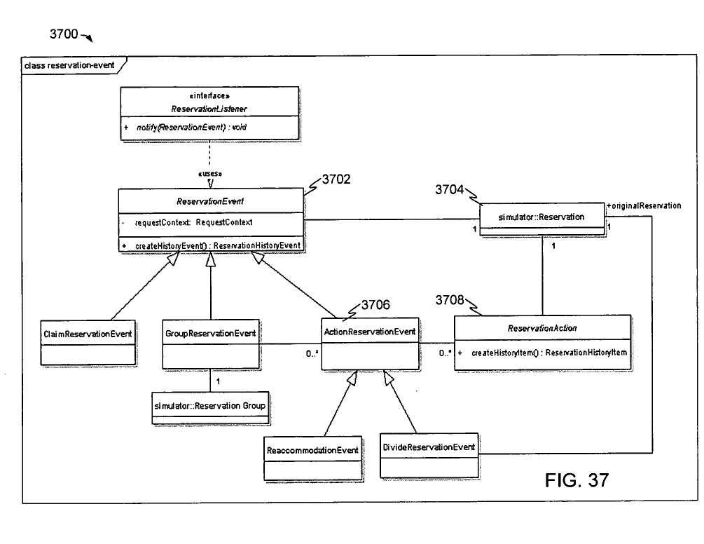

FIG. 37 is a graphic illustration of an exemplary reservation events environment 3700, including a class hierarchy of ReservationEvents.

A ReservationEvent 3702 may be associated with a Reservation 3704 that is created or modified. An ActionReservationEvent 3706 may include a list of modifications to Reservation 3704, which may include one or more ReservationActions 3708. One or more event classes may be configured, such as a ClaimReservationEvent 3710 and a GroupReservationEvent 3712.

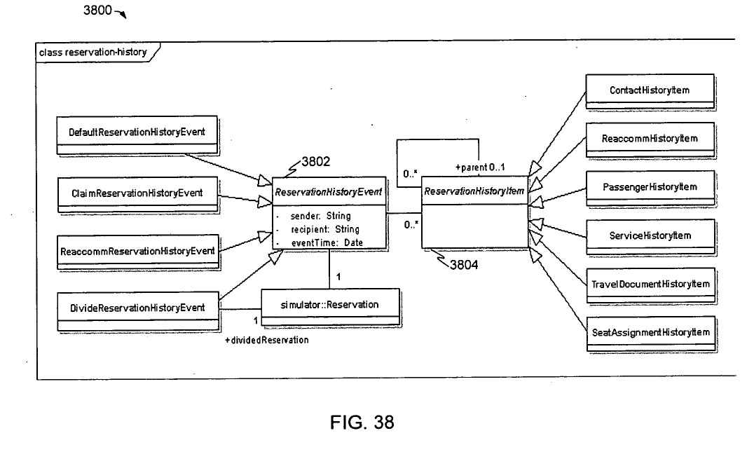

A ReservationEvent 3702 may be used for generating auditing information, which may be maintained as master-detail objects. FIG. 38 is a graphic illustration of a reservation history event environment 3800, including a ReservationHistoryEvent 3802 and a ReservationHistoryItem 3804. ReservationEvent 3702 (FIG. 37) may be stored as ReservationHistoryEvent 3802, and ReservationAction 3708 (FIG. 37) may be stored as ReservationHistoryItem 3804 associated with ReservationHistoryEvent 3802.

Processing of EDIFACT booking messages is now described. When booking a reservation in a GDS, the GDS may be configured to send a message to one or more airlines. A corresponding protocol may call for the booking information to be contained as an AIRIMP message inside of a single text element of an EDIFACT message. Such a message is referred to herein as an EDIFACT Hybrid Wrapup (HWPREQ) message.

When processing an HWPREQ message, an AIRIMP reservation handler may be re-used and applied to the wrapped or embedded AIRIMP message.

Exemplary processing of outgoing messages or notifications is now described.

A reservation session may be configured to send a ReservationEvent to a ReservationListener. Outgoing messaging may be implemented with one or more ReservationListener.

Simulator 304 may include a RuleBasedReservationListener to generate outgoing messages or notifications to one or more AISs. The RuleBasedReservationListener may be configured to determine which system or systems to be notified, and to send a corresponding notification through one or more corresponding channels in accordance with parameters and/or rules associated with a sending TravelSystem or simulated AIS 406.

A determination as to which system to notify may depend on properties of the corresponding reservation and/or changes performed on the reservation. For example, the determination may depend on roles of other systems with respect to segments of the reservation.

Simulator 304 may include ReservationEventRules to determine which system to notify.

Simulator 304 may include ReservationChannels to determine or define how to communicate with other AISs, such as which message to send and how to send it.

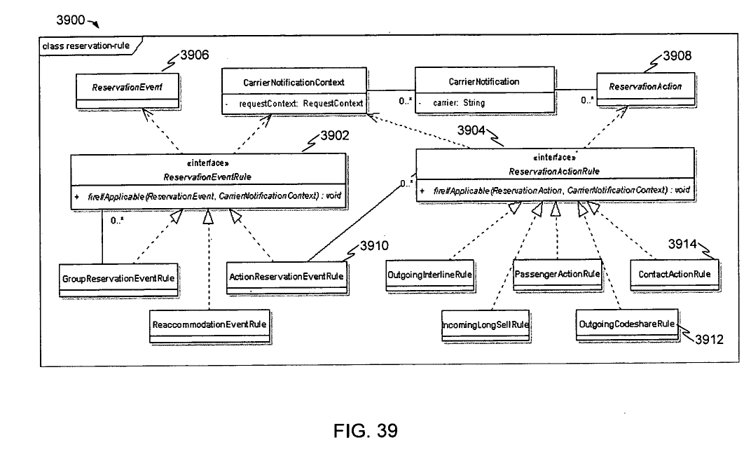

FIG. 39 is a graphic illustration of a reservation rules environment 3900, including exemplary rule classes to determine which system has to be notified about a reservation change. In the example of FIG. 39, environment 3900 includes a ReservationEventRule 3902 and a ReservationActionRule 3904.

ReservationEventRule 3902 may apply to a ReservationEvent 3906.

ReservationActionRule 3904 may apply to a ReservationAction 3908 associated with ReservationEvent 3906.

An ActionReservationEventRule 3910 may be configured as a link between ReservationEventRule 3902 and ReservationActionRule 3904.

ReservationEventRule 3902 may include a list of ReservationActionRules 3904 to be applied to ReservationActions 3908 within ReservationEvent 3906.

Rules, such as business rules, may be specific to a particular action and may be embodied as implementations of ReservationActionRule 3904, which may include one or more of an OutgoingCodeshareRule 3912 and a ContactActionRule 3914. For example, OutgoingCodeshareRule 3912 may apply to SegmentActions. When an action relates to a change to a segment, OutgoingCodeshareRule 3912 may determine that the action was in response to a message to a recipient simulated AIS 406, that the recipient simulated AIS 406 markets the segment on behalf of an operating airline, and that the operating airline is to be notified of the action.

An action rule may be configured to determine whether it is applicable to an action and, if so, to determine which system is to be notified of the action. Alternatively, or additionally, simulator 304 may be configured to match action rules with the type of action to which they apply.

Reservation channels are now described.

A ReservationChannel may be configured to generate and/or configure an outgoing message or notification.

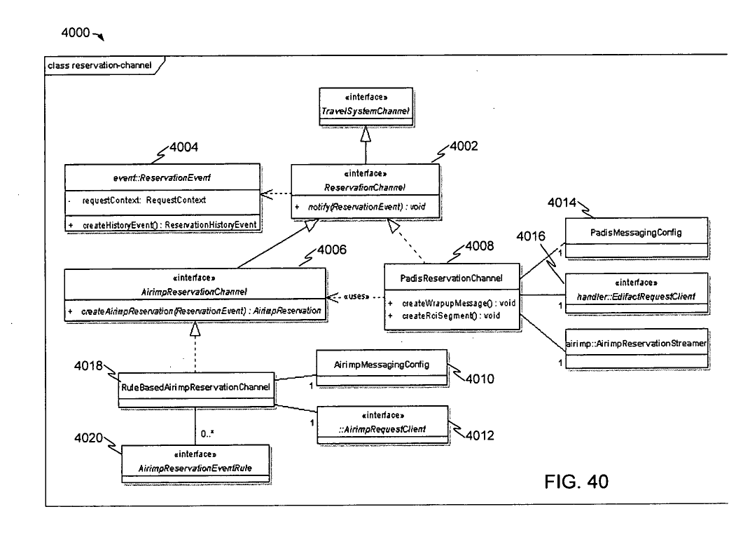

FIG. 40 is a graphic illustration of a reservation channel environment 4000, including a ReservationChannel 4002 to handle a ReservationEvent 4004. Environment 4000 may include one or more content type reservation channels, which may include one or more of an AirimpReservationChannel 4006 and a PadisReservationChannel 4008.

PadisReservationChannel 4008 may be configured to use AirimpReservationChannel 4006.

For EDIFACT messaging, such as from a simulated GDS, and where a booking message (HWPREQ) is a wrapper around an AIRIMP message, PadisReservationChannel 4008 may be configured to use AirimpReservationChannel 4006 to construct such messages.

In the example of FIG. 40, AirimpReservationChannel 4006 is linked to a AirimpMessagingConfig 4010 and a AirimpRequestClient 4012, and PadisReservationChannel 4008 is linked to a PadisMessagingConfig 4014 and a PadisRequestClient 4016. AirimpMessagingConfig 4010 and PadisMessagingConfig 4014 may include channel specific parameters to be used when constructing corresponding messages. Separation of configuration parameters and client objects may permit re-use of channel classes for channels between different systems.

Exemplary AIRIMP reservation event rules are now described.

ReservationEventRules 3902 (FIG. 39) may include AIRIMP-specific rules to be applied to ReservationEvents for which an AIRIMP channel is being notified, to determine how to notify a recipient.

Simulator 304 may include a RuleBasedAirimpReservationChannel 4018 configured to use AIRIMP-specific rules to construct outgoing AIRIMP messages. RuleBasedAirimpReservationChannel 4018 may include a list of one or more AirimpReservationEventRules 4020 which may be applied to an event for which RuleBasedAirimpReservationChannel 4018 is notified.

Simulator 304 may include an AirimpActionReservationEventRule, which may include a list of one or more AirimpReservationActionRules to be applied to a corresponding ReservationAction. The one or more AirimpReservationActionRules may be configured to modify an AIRIMP notification message.

AIRIMP rules may be passed the corresponding original request context along with an AirimpGenerationContext that includes the AIRIMP message being built, along with an AirimpMessagingConfig passed in by the AIRIMP channel.

AirimpReservationEventRules may include one or more of:

an AirimpClaimReservationEventRule;

an AirimpCommunicationHeaderRule;

an AirimpDivideReservationEventRule;

an AirimpGroupReservationEventRule;

an AirimpPassengerRule;

an AirimpReaccomReservationEventRule;

an AirimpContactActionRule;

an AirimpLocatorRule; and

an AirimpReservationActionRule.

An AirimpLocatorRule may be configured to create AIRIMP locator lines for an outgoing message, such as a primary locator of the reservation and a foreign locator of a partner to be notified. An AirimpLocatorRule may be configured to determine an order in which the locators appear. The determination may be based on the segment types in the message. For example, where there is an interline segment marketed by a partner to be notified, or where there is a codeshare segment operated by the partner to be notified, and where the recipient of the message is also a requester, a primary locator may come first.

AirimpReservationEventRules may include a plurality of types of AirimpReservationActionRules corresponding a plurality of types of ReservationActions.

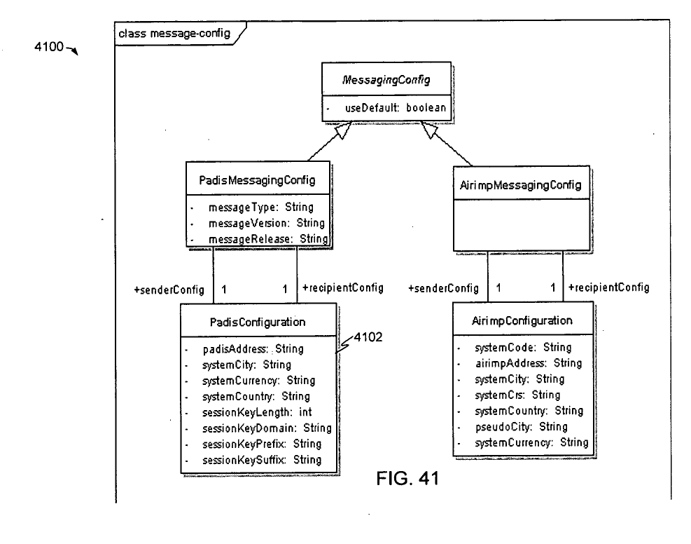

FIG. 41 is a graphic illustration of an exemplary reservation channel configuration environment 4100, including exemplary objects to configure reservation channels.

In the example of FIG. 41, environment 4100 includes a PadisConfiguration 4102 and an ArimpConfiguration 4104, each including system-specific information of a sender or current travel system, and receiver or system to be notified. System-specific information may include an address and identification associated with a system. In case of PADIS, this information also contains the format of the session key. PadisConfiguration 4102 may further include a session key format, a message type, and version to be used.

Simulator 304 may be configured to create or modify outgoing messages or notifications to reflect variances identified in live messages between AISs.

Variance may be captured by comparing logs of such messages and identifying differences that are particular or unique to one or more AISs. A variance associated with a message type may be captured or represented as an attribute a MessagingConfig.

For a message variance that applies to all PADIS messages, such as a variance in a UNB/UNH segment, properties may be added to a PadisMessagingConfig and a MessageHeaderConfiguration. Where there are fields for both sender and recipient, such as system address, and/or session key length, the configuration in PadisConfiguration may be used. For variance that applies to a specific message type, such as ITAREQ, a specific configuration class may used, such as a PadisItareqMessagingConfig. A message-specific configuration may specify whether one or more fields are to be included in a message, and may include system-specific values for the one or more fields.

A channel class, such as a PadisInventoryChannel, may be configured to use one or more message-specific configuration classes and to apply corresponding attributes to an outgoing message.

Where PADIS channels use a PadisRequestBuilder to build headers of outgoing messages, the PadisMessagingConfig may be passed in a constructor of a request builder to allow for variance to be applied. PADIS addresses for sender and recipient values in a UNB segment may be retrieved from the PadisMessagingConfig, along with other details such as session key type and length, message type version and release.

Exemplary reservation listeners are now described.

Configuration of outgoing messages or notifications may depend on a corresponding or current travel system. Simulator 304 may include a RuleBasedReservationListener configured to ask a TravelSystem for corresponding rules and to apply the rules to a reservation event.

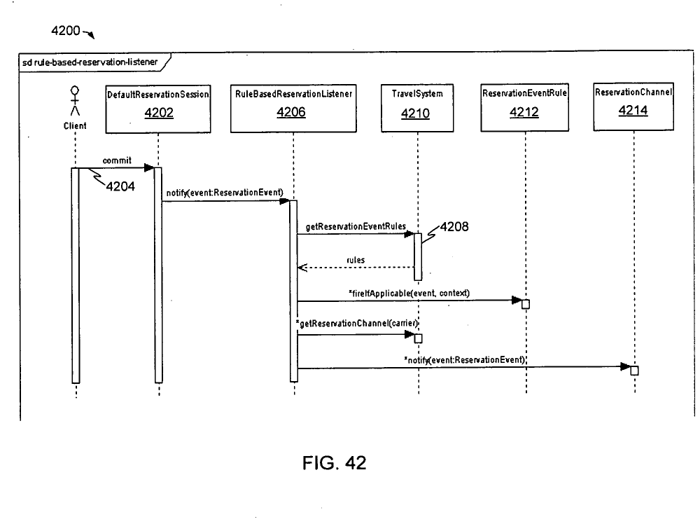

FIG. 42 is a graphic illustration of an exemplary rule-based reservation listener environment 4200, including a DefaultReservationSession 4202. When a reservation session is committed at 4204, DefaultReservationSession 4202 notifies a listener, illustrated in FIG. 42 as a RuleBasedReservationListener 4206 of changes identified in a corresponding ReservationEvent. At 4208, RuleBasedReservationListener 4206 asks a corresponding TravelSystem 4210 for one or more ReservationEventRules 4212. TravelSystem 4210 may be obtained from the ReservationEvent.

Upon application of ReservationEventRules 4212, RuleBasedReservationListener 4206 determines which system or systems are to be notified of the changes within the ReservationEvent. For each system to be notified, RuleBasedReservationListener 4206 asks TravelSystem 3210 for a corresponding ReservationChannel 4214 and forwards the ReservationEvent to ReservationChannel 4214.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

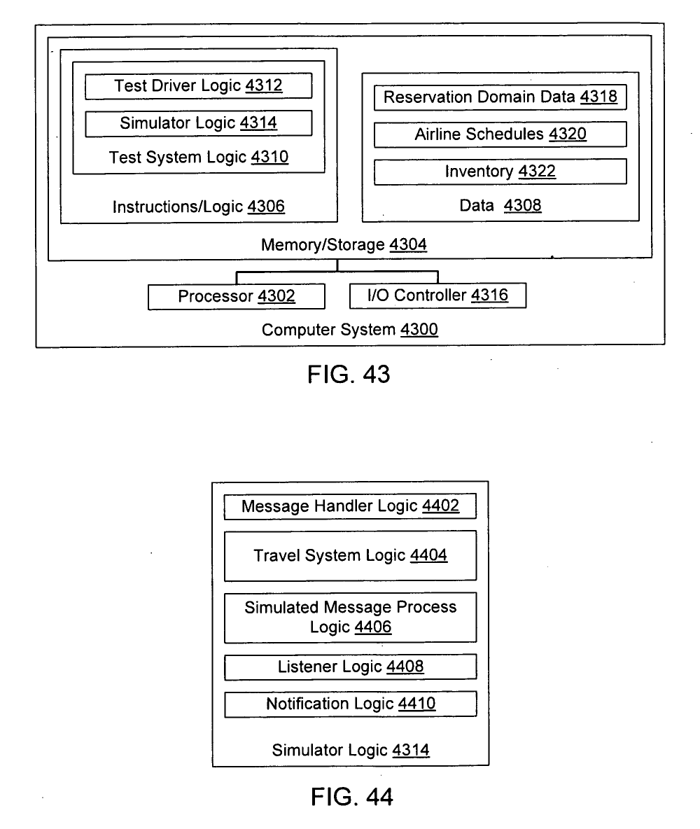

FIG. 43 is a block diagram of an exemplary computer system 4300, including one or more instruction processors, illustrated here as a processor 4302, to execute computer program logic, also known as instructions, code, and software.

Computer system 4300 may include memory/storage 4304, which may include a computer readable medium having computer program logic or instructions 4306 stored thereon, to cause processor 4302 to perform one or more functions in response thereto.

Memory/storage 4304 may include data 4308 to be used by processor 4302 in executing logic 4306, and/or generated by processor 4302 in response to execution of logic 4306.

In the example of FIG. 43, logic 4306 includes test system logic 4310, which may include test driver logic 4312 to cause processor 4302 to generate test commands and/or information, and to retrieve corresponding results. Test driver logic 4312 may include logic to cause processor 4302 to stimulate AISUT 104 in FIG. 1. Test driver logic 4312 may include logic to cause processor 4302 to stimulate one or more simulated AISs 406 in FIG. 4.

Test system logic 4310 may include simulator logic 4314 to cause processor 4302 to simulate operations of one or more AISs, such as simulated AISs 406 in FIG. 4. Simulator logic 4314 may include logic to cause processor 4302 to simulate operations of one or more AISs in response to stimulation generated under control of test driver logic 4312 and/or in response to messages received from AISUT 104, which may include messages generated in response to simulation generated under control of test driver logic 4312.

Computer system 4300 may include an input/output (I/O) controller 4316 to communicate with one or more other systems, such as AISUT 104. I/O controller 4316 may include one or more transport protocol interface controllers, which may include one or more of an HTTP interface controller, a BATAP over MATIP interface controller, and an HTH interface controller. Alternatively, AISUT 104, or portions thereof, may be implemented within logic 4306 of computer system 4300.

I/O controller 4316 may include a network interface card (NIC) to communicate through one or more networks. I/O controller 4316 may include one or more human interface device (HID) interfaces, which may include one or more of a display interface, a keyboard interface, and a pointing device interface.

Data 4308 may include one or more of reservation domain data 4318, airline schedules 4320, and inventory information 4320.

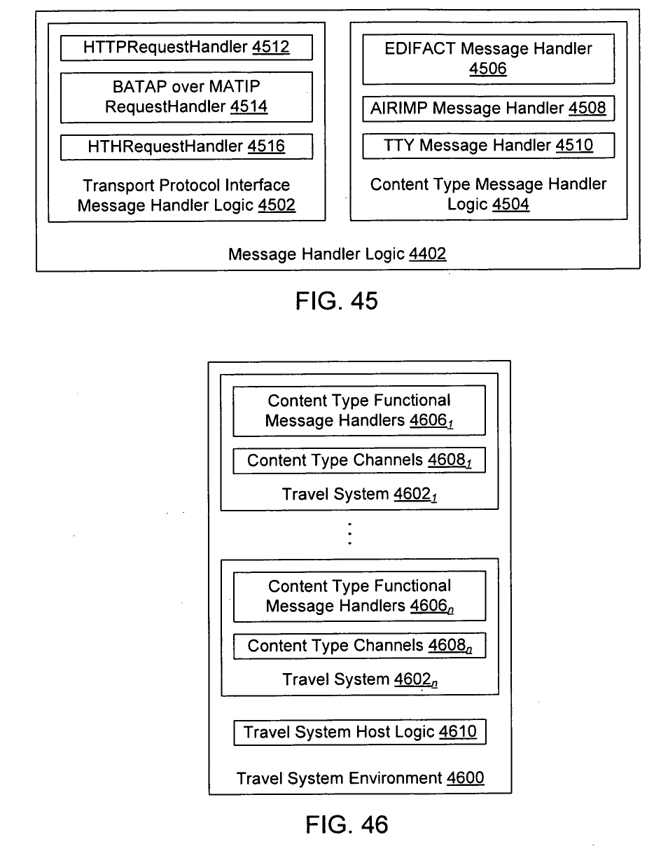

FIG. 44 is an exemplary block diagram of simulator logic 4314, including message handler logic 4402 to cause processor 4302 to parse and format messages received over one or more transport protocol interfaces, in accordance with corresponding message content types. FIG. 45 is an exemplary block diagram of message handler logic 4402, including transport protocol interface message handler logic 4502 and content type message handler logic 4504.

Content type message handler logic 4504 may include one or more of an EDIFACT message handler 4506, an AIRIMP message handler 4508, and a teletype message handler 4510, each including logic to cause processor 4302 to parse message content from corresponding content type messages.

Transport protocol interface message handler logic 4502 may include one or more of an HTTPRequestHandler 4512, a BATAP over MATIP RequestHandler 4514, and a HTHRequestHandler 4516, each including logic to cause processor 4302 to receive messages over a corresponding transport protocol interface and to identify corresponding recipient simulated AISs 406 and message handlers to parse and format the messages in accordance with corresponding message content types.

Returning to FIG. 44, simulator logic 4314 further includes travel system logic 4404 to cause processor 4302 to configure one or more travel systems to represent corresponding simulated AISs 406.

FIG. 46 is a block diagram of an exemplary travel system environment 4600 including travel systems 4602₁ through 4602ₙ. One or more of travel systems 4602 may include and/or be associated with one or more content type functional message handlers 4606 and/or one or more content type channels 4608, which may be configured in accordance with rules associated with messaging between a corresponding AIS and other AISs.

Travel system environment 4600 may include travel system host logic 4610, which may include logic to cause processor 4302 to manage access to travel systems 4602.

In FIG. 45, one or more message handlers 4506, 4508, and 4510 may include logic to cause processor 4302 to call or invoke content type functional message handlers 4606 in FIG. 46 to format corresponding content type messages in accordance with travel system specific parameters.

Returning to FIG. 44, simulator logic 4314 further includes simulated message process logic 4406 to cause processor 4302 to process messages formatted in accordance with corresponding message content types. Simulated message process logic 4406 may include logic to simulate message processing of one or more simulated AISs 406 in FIG. 4, and may include, for example and without limitation, booking request processing logic.

Returning to FIG. 44, simulator logic 4314 may include one or more of listener logic 4408 and notification logic 4410, to cause processor 4302 to identify AISs to be notified in response to changes that result from message process logic 4406, to identify travel systems 4602 (FIG. 46) responsible for the changes, and to prepare corresponding notifications in accordance with content type channels 4608 (FIG. 46) of the identified travel systems 4602.

Features that may vary amongst simulated AISs 406 may be modeled within corresponding travel systems 4602 and other logic may be configured substantially independent of features that may vary amongst simulated AISs 406. This may permit additions to and/or modifications of travel systems 4602 substantially without impact to the other logic. Similarly, this may permit additions to and/or modification of the other logic substantially without impact to travel systems 4602. For example, one or more of simulated message process logic 4406, message handler logic 4404, listener logic 4408, and notification logic 4410, may be configured substantially independent of features that may vary amongst simulated AISs 406. Similarly, simulated message process logic 4406, message handler logic 4404, listener logic 4408, and notification logic 4410, or portions thereof, may be configured substantially independent of one another.

Methods and systems have been disclosed herein with the aid of functional building blocks illustrating the functions, features, and relationships thereof. At least some of the boundaries of these functional building blocks have been arbitrarily defined herein for the convenience of the description. Alternate boundaries can be defined so long as the specified functions and relationships thereof are appropriately performed.

One skilled in the art will recognize that these functional building blocks can be implemented by discrete components, application specific integrated circuits, processors executing appropriate software, and combinations thereof.

While various embodiments been described above, it should be understood that they have been presented by way of example only, and not limitation. It will be apparent to persons skilled in the relevant art that various changes in form and detail can be made therein without departing from the spirit and scope of the methods and systems disclosed herein. Thus, the breadth and scope of the claims should not be limited by any of the above-described exemplary embodiments. It is to be appreciated that the Detailed Description section, and not the Abstract, is intended to be used to interpret the claims.

What is claimed is:

1. A computer program product including a computer readable medium having computer program logic stored therein, the computer program logic comprising:
simulator logic to cause a processor to simulate operations of a plurality of airline information systems (AISs), including to send and receive messages between the simulated AISs and to send messages to and receive messages from an AIS under test (AISUT), in accordance with communication parameters associated with the corresponding AISs and AISUT; and
test driver logic to cause the processor to stimulate one or more of the AISUT and one or more of the simulated AISs, to receive information from one or more of the AISUT and one or more of the simulated AISs subsequent to the simulation, and to associate the information with an indication of the simulation.

2. The computer program product of claim 1, wherein the simulator logic includes:
logic to cause the processor to represent the AISs as corresponding travel system objects;
logic to cause the processor to associate the travel system objects with corresponding message parameters to process messages from other AISs, including content type message parameters corresponding to one or more of XML, EDIFACT, and teletype message content types;
receive logic to cause the processor to receive messages directed to one or more of the AISs;
logic to cause the processor to parse contents from the messages in accordance with the corresponding content types;
logic to cause the processor to format the parsed contents in accordance with the message parameters associated with the corresponding recipient travel system objects; and
logic to cause the processor to process instructions contained within the formatted parsed message contents.

3. The computer program product of claim 2, wherein the receive logic includes:
logic to cause the processor to receive the messages over a transport protocol interface;
logic to cause the processor to identify corresponding recipient travel system objects and content types from the messages; and
logic to cause the processor to invoke corresponding content type message handlers to parse the message contents.

4. The computer program product of claim 2, wherein the simulator logic further includes:
logic to cause the processor to associate the travel system objects with corresponding channel parameters to configure notifications to other AISs, including content type parameters corresponding to one or more of XML, EDIFACT, and teletype message content types;
logic to cause the processor to configure event objects with indications of actions performed in response to the instructions contained within the formatted parsed messages, and to associate the event objects with corresponding received messages;
logic to cause the processor to identify travel system objects associated with the event objects and corresponding received messages;
logic to cause the processor to identify AISs to be notified and corresponding notification content types from the channel parameters of the identified travel system objects; and
logic to cause the processor to configure corresponding notifications in accordance with the channel parameters and event objects.

5. The computer program product of claim 1, wherein:
the simulator logic includes logic to cause the processor to receive a booking request message directed to a first one of the simulated AISs, to revise reservation information in accordance with the booking request message and message handling parameters of the first simulated AIS, and to generate a corresponding notification to one or more of another simulated AIS and the AISUT in accordance with notification parameters of the first simulated AIS; and
the test driver logic includes logic to cause the processor to receive one or more of an indication of the revised reservation information and one or more messages exchanged between the first simulated AIS and one or more of another simulated AIS and the AISUT.

6. The computer program product of claim 1, wherein:
the test driver logic includes logic to cause the processor to send a travel agent terminal-type booking request message to the AISUT; and
the simulator logic includes logic to cause the processor to receive a message from the AISUT directed to a first one of the simulated AISs in response to the booking request message, to process the message in accordance with message handling parameters of the first simulated AIS, and to generate a notification to one or more of another simulated AIS and the AISUT in accordance with notification parameters of the first simulated AIS.

7. The computer program product of claim 1, wherein:
the test driver logic includes logic to cause the processor to invoke a browser application to initiate a booking request through a web application of the AISUT; and
the simulator logic includes logic to cause the processor to receive a message from the AISUT directed to a first one of the simulated AISs in response to the stimulation, to process the message in accordance with message handling parameters of the first simulated AIS, and to generate a notification to one or more of another simulated AIS and the AISUT in accordance with notification parameters associated with the first simulated AIS.

8. The computer program product of claim 7, wherein the test driver logic includes logic to cause the processor to record at least a portion of a graphical user interface display associated the browser application.

9. The computer program product of claim 1, wherein:
the test driver logic includes logic to cause the processor to stimulate a simulated global distribution system (GDS) AIS to send a booking request message to the AISUT; and
the simulator logic includes logic to cause the processor to generate a booking request message to the AISUT in accordance with parameters associated with the simulated GDS AIS in response to the simulation, to receive messages from the AISUT directed to the simulated GDS AIS and to a partner airline simulated AIS in response to the booking request message, to process the received messages in accordance with corresponding message handling parameters of the simulated GDS AIS and the partner airline simulated AIS, and to generate notifications to one or more of another simulated AIS and the AISUT in accordance with corresponding notification parameters associated with the simulated GDS AIS and the partner airline simulated AIS.

10. The computer program product of claim 1, wherein the simulator logic includes:
receive logic to cause the processor to receive a plurality of message content types over a protocol interface, including one or more of XML message content types, EDIFACT message content types, and AIRIMP message content types; and
logic to cause the processor to parse the messages under control of corresponding message content type message handlers.

11. The computer program product of claim 10, wherein the receive logic includes:
logic to cause the processor to receive the plurality of message content types formatted in accordance with one or of a hypertext transfer protocol (HTTP) and an airline protocol;
logic to cause the processor to identify corresponding message content types from the messages; and
logic to cause the processor to invoke the corresponding message content type handlers to parse the messages.

12. The computer program product of claim 10, wherein the computer program logic further includes:
EDIFACT definitions encoded in a machine readable XML format;
logic to cause the processor to generate object definitions from the encoded EDIFACT definitions;
logic to cause the processor to read the XML file upon initiation of the processor and to construct objects corresponding to the EDIFACT definitions upon initiation of the processor; and
logic to cause the processor to invoke the objects to process received EDIFACT messages and to prepare EDIFACT response messages.

13. The computer program product of claim 1, wherein the simulator logic includes:
logic to cause the processor to send and receive messages between the simulated AISs and to send messages to and receive messages from the in accordance with business rules that govern message formats and interpretations between the AISs and between the AISs and the AISUT.

14. The computer program product of claim 1, wherein the test driver logic includes one or more of:
logic to cause the processor to stimulate a simulated AIS to initiate a booking request; and
logic to cause the processor to stimulate the AISUT to initiate a booking request.

15. The computer program product of claim 1, wherein the simulator logic includes logic to cause the processor to simulate booking operations of an AIS.

16. The computer program product of claim 15, wherein the simulator logic includes one or more of:
logic to cause the processor to process message directed to an AIS relating to passenger information;
logic to cause the processor to process message directed to an AIS relating to travel itinerary preferences;
logic to cause the processor to process message directed to an AIS relating to seating availability;
logic to cause the processor to process message directed to an AIS relating to booking requests;
logic to cause the processor to process message directed to an AIS relating to booking change requests;
logic to cause the processor to process message directed to an AIS relating to booking cancellations;
logic to cause the processor to process message directed to an AIS relating to flight schedule information;
logic to cause the processor to process message directed to an AIS relating to flight schedule changes;
logic to cause the processor to process message directed to an AIS relating to flight cancellations;
logic to cause the processor to process message directed to an AIS relating to flight delays;
logic to cause the processor to process message directed to an AIS relating to inventory information;
logic to cause the processor to process message directed to an AIS relating to departure control information; and
logic to cause the processor to process message directed to an AIS relating to payments.

17. The computer program product of claim 1, wherein the simulator logic includes:
travel system logic to cause the processor to represent the AISs as corresponding travel system objects and to associate the travel system objects with corresponding AIS-specific message handling and reporting parameters; and
instruction logic to cause the processor to process message instructions directed to a plurality of the simulated AISs;
wherein the travel systems and the instruction logic are modifiable independent of one another.

18. A computer implemented method, comprising:
simulating operations of a plurality of airline information systems (AISs) in a computer system, including sending and receiving messages between the simulated AISs and sending messages to and receiving messages from an AIS under test (AISUT), in accordance with communication parameters associated with the corresponding AISs and AISUT;
stimulating one or more of the AISUT and one or more of the simulated AISs, from the computer system, to cause interaction between the AISUT and one or more of the simulated AISs;
receiving information associated with the interaction, in the computer system; and
associating the information with an indication of the simulating, in the computer system.

19. The method of claim 18, wherein the simulating includes:
representing the AISs as corresponding travel system objects;
associating the travel system objects with corresponding message parameters to process messages from other AISs, including content type message parameters corresponding to one or more of XML, EDIFACT, and teletype message content types;
receiving messages directed to one or more of the AISs;
parsing contents from the messages in accordance with the corresponding content types;
formatting the parsed contents in accordance with the message parameters associated with the corresponding recipient travel system objects; and
processing instructions contained within the formatted parsed message contents.

20. The method of claim 19, wherein the receiving of messages directed to one or more of the AISs includes:
receiving the messages over a transport protocol interface;
identifying corresponding recipient travel system objects and content types from the messages; and
invoking corresponding content type message handlers to parse the message contents.

21. The method of claim 19, wherein the simulating further includes:
associating the travel system objects with corresponding channel parameters to configure notifications to other AISs, including content type parameters corresponding to one or more of XML, EDIFACT, and teletype message content types;
configuring event objects with indications of actions performed in response to the processing of the instructions, and associating the event objects with corresponding received messages;
identifying travel system objects associated with the event objects and corresponding received messages;
identifying AISs to be notified and corresponding notification content types from the channel parameters of the identified travel system objects; and
configuring corresponding notifications in accordance with the channel parameters and event objects.

22. The method of claim 18, wherein:
the simulating includes receiving a booking request message directed to a first one of the simulated AISs, revising reservation information in accordance with the booking request message and message handling parameters of the first simulated AIS, and generating a corresponding notification to one or more of another simulated AIS and the AISUT in accordance with notification parameters of the first simulated AIS; and
the receiving information includes receiving one or more of an indication of the revised reservation information and one or more messages exchanged between the first simulated AIS and one or more of another simulated AIS and the AISUT.

23. The method of claim 18, wherein:
the stimulating includes sending a travel agent terminal-type booking request message to the AISUT; and
the simulating includes receiving a message from the AISUT directed to a first one of the simulated AISs in response to the booking request message, processing the message in accordance with message handling parameters of the first simulated AIS, and generating a notification to one or more of another simulated AIS and the AISUT in accordance with notification parameters of the first simulated AIS.

24. The method of claim 18, wherein:
the stimulating includes invoking a browser application in the computer system to initiate a booking request through a web application of the AISUT; and
the simulating includes receiving a message from the AISUT directed to a first one of the simulated AISs in response to the stimulating, processing the message in accordance with message handling parameters of the first simulated AIS, and generating a notification to one or more of another simulated AIS and the AISUT in accordance with notification parameters associated with the first simulated AIS.

25. The method of claim 24, wherein the receiving information includes recording at least a portion of a graphical user interface display associated the browser application.

26. The method of claim 18, wherein:
the stimulating includes stimulating a simulated global distribution system (GDS) AIS to send a booking request message to the AISUT; and
the simulating includes generating a booking request message to the AISUT in accordance with parameters associated with the simulated GDS AIS in response to the simulating, receiving messages from the AISUT directed to the simulated GDS AIS and to a partner airline simulated AIS in response to the booking request message, processing the received messages in accordance with corresponding message handling parameters of the simulated GDS AIS and the partner airline simulated AIS, and generating notifications to one or more of another simulated AIS and the AISUT in accordance with corresponding notification parameters associated with the simulated GDS AIS and the partner airline simulated AIS.

27. The method of claim 18, wherein the simulating includes:
receiving a plurality of message content types over a protocol interface, including one or more of XML message content types, EDIFACT message content types, and AIRIMP message content types; and
parsing the messages under control of corresponding message content type message handlers.

28. The method of claim 27, wherein the receiving of the plurality of message content types includes:
receiving the plurality of message content types formatted in accordance with one or of a hypertext transfer protocol (HTTP) and an airling protocol;
identifying corresponding message content types from the messages; and
invoking the corresponding message content type handlers to parse the messages.

29. The method of claim 27, further including:
encoding EDIFACT definitions in a machine readable XML format;
generating object definitions from the encoded EDIFACT definitions;
reading the XML file upon initiation of the computer system and constructing objects corresponding to the EDIFACT definitions upon initiation of the computer system; and
invoking the objects to process received EDIFACT messages and to prepare EDIFACT response messages.

30. The method of claim 18, wherein the sending and receiving of messages between the simulated AISs, and the sending messages to and the receiving messages from the AISUT, includes sending and receiving the messages in accordance with business rules that govern message formats and interpretations between the AISs and between the AISs and the AISUT.

31. The method of claim 18, wherein the stimulating includes one or more of:
stimulating a simulated AIS to initiate a booking request; and
stimulating the AISUT to initiate a booking request.

32. The method of claim 18, wherein the simulating includes simulating booking operations of an AIS.

33. The method of claim 32, wherein the simulating includes processing messages directed to an AIS relating to one or more of:
passenger information;
travel itinerary preferences;
seating availability;
booking requests;
booking change requests;
booking cancellations;
flight schedule information;
flight schedule changes;
flight cancellations;
flight delays;
inventory information;
departure control information; and
payment.

34. The method of claim 18, wherein simulating includes:
representing the AISs as corresponding travel system objects and associating the travel system objects with corresponding AIS-specific message handling and reporting parameters; and
processing message instructions directed to a plurality of the simulated AISs under control of instruction logic;
wherein the travel systems and the instruction logic are modifiable independent of one another.

35. A system, comprising:
simulator system to simulate operations of a plurality of airline information systems (AISs), including to send and receive messages between the simulated AISs and to send messages to and receive messages from an AIS under test (AISUT), in accordance with communication parameters associated with the corresponding AISs and AISUT;
a test driver system to stimulate one or more of the AISUT and one or more of the simulated AISs, to receive information from one or more of the AISUT and one or more of the simulated AISs subsequent to the simulation, and to associate the information with an indication of the simulation.

36. The system of claim 35, wherein the simulator system includes:
logic to represent the AISs as corresponding travel system objects;
logic to associate the travel system objects with corresponding message parameters to process messages from other AISs, including content type message parameters corresponding to one or more of XML, EDIFACT, and teletype message content types;
logic to receive messages directed to one or more of the AISs;
logic to parse contents from the messages in accordance with the corresponding content types;
logic to format the parsed contents in accordance with the message parameters associated with the corresponding recipient travel system objects; and
logic to process instructions contained within the formatted parsed message contents.

37. The system of claim 36, wherein the simulator system further includes:
logic to associate the travel system objects with corresponding channel parameters to configure notifications to other AISs, including content type parameters corresponding to one or more of XML, EDIFACT, and teletype message content types;
logic to configure event objects with indications of actions performed in response to the instructions contained within the formatted parsed messages, and to associate the event objects with corresponding received messages;
logic to identify travel system objects associated with the event objects and corresponding received messages;
logic to identify AISs to be notified and corresponding notification content types from the channel parameters of the identified travel system objects; and
logic to configure corresponding notifications in accordance with the channel parameters and event objects.

38. The system of claim 35, wherein the simulator system includes:
travel system logic to represent the AISs as corresponding travel system objects and to associate the travel system objects with corresponding AIS-specific message handling and reporting parameters; and
instruction logic to process message instructions directed to a plurality of the simulated AISs;
wherein the travel systems and the instruction logic are modifiable independent of one another.

39. A system, comprising:
means for simulating operations of a plurality of airline information systems (AISs) in a computer system, including sending and receiving messages between the simulated AISs and sending messages to and receiving messages from an AIS under test (AISUT), in accordance with communication parameters associated with the corresponding AISs and AISUT;
means for stimulating one or more of the AISUT and one or more of the simulated AISs, from the computer system, to cause interaction between the AISUT and one or more of the simulated AISs;
means for receiving information associated with the interaction, in the computer system; and
means for associating the information with an indication of the simulating, in the computer system.

40. The system of claim 39, wherein the means for simulating includes:
means for representing the AISs as corresponding travel system objects;
means for associating the travel system objects with corresponding message parameters to process messages from other AISs, including content type message parameters corresponding to one or more of XML, EDIFACT, and teletype message content types;
means for receiving messages directed to one or more of the AISs;
means for parsing contents from the messages in accordance with the corresponding content types;
means for formatting the parsed contents in accordance with the message parameters associated with the corresponding recipient travel system objects; and
means for processing instructions contained within the formatted parsed message contents.

41. The system of claim 40, wherein the means for simulating further includes:
means for associating the travel system objects with corresponding channel parameters to configure notifications to other AISs, including content type parameters corresponding to one or more of XML, EDIFACT, and teletype message content types;
means for configuring event objects with indications of actions performed in response to the processing of the instructions, and associating the event objects with corresponding received messages;
means for identifying travel system objects associated with the event objects and corresponding received messages;
means for identifying AISs to be notified and corresponding notification content types from the channel parameters of the identified travel system objects; and
means for configuring corresponding notifications in accordance with the channel parameters and event objects.

42. The system of claim 39, wherein means for simulating includes:
means for representing the AISs as corresponding travel system objects and for associating the travel system objects with corresponding AIS-specific message handling and reporting parameters;
instruction logic means for processing message instructions directed to a plurality of the simulated AISs under control of instruction logic; and
means for modifying the travel systems and the instruction logic independent of one another.
